(19) United States
(12) Patent Application Publication
(10) Pub. No.: US 2013/0227896 A1
(43) Pub. Date: Sep. 5, 2013

(54) Building Panels Having Hook and Loop Seams, Building Structures, and Systems and Methods for Making Building Panels

(71) Applicants: Todd E. Anderson, Duncansville, PA (US); Frederick Morello, Johnstown, PA (US)

(72) Inventors: Todd E. Anderson, Duncansville, PA (US); Frederick Morello, Johnstown, PA (US)

(73) Assignee: M.I.C. Industries, Inc., Reston, VA (US)

(21) Appl. No.: 13/411,107

(22) Filed: Mar. 2, 2012

(51) Int. Cl. E04B 1/32; B23P 23/00; B23P 17/04; E04B 2/00

(52) U.S. Cl. 52/86; 52/588.1; 29/33 R; 29/592

(57) ABSTRACT

A building panel formed from sheet material is disclosed, the building panel extending in a longitudinal direction along its length and having a shape in cross section in a plane perpendicular to the longitudinal direction. The building panel includes a center portion in cross section, a first connecting portion connected at one side of the center portion, the first connecting portion comprising a loop in cross section, and a second connecting portion connected at an opposing side of the center portion, the second connecting portion comprising a hook in cross section, wherein the loop and the hook are complementary in size and shape for joining the building panel to adjacent building panels. Building structures comprised of such building panels, and methods and systems for forming such building panels are also disclosed.

### BACKGROUND

1. Field of the Disclosure

The present disclosure relates to building panels having a novel hook and loop seam, building structures made using such building panels, and a system for fabricating such building panels.

2. Background Information

Conventional methods are known in the art for forming non-planar building panels made from sheet material, e.g., galvanized steel sheet metal. Such building panels can be attached side-by-side to form self-supporting building structures by virtue of the strength of the building panels themselves. That is, such building panels can exhibit a moment of inertia suitable to provide enough strength under applied loads (e.g., snow, wind, etc.) so that supporting beams or columns within the building structure are unnecessary.

FIG. 1 illustrates an exemplary cross sectional shape of a conventional building panel 10. The building panel 10 includes a curved center portion 30, a pair of side portions 36 and 38 extending from the curved center portion 30 in cross section, and a pair of connecting portions 32 and 34 extending from the side portions 36 and 38, respectively, in cross section. Connecting portion 32 includes a hook portion 32a, and connecting portion 34 includes a hem portion 34a. The hook portion 32a and the hem portion 34a are complementary in shape for joining adjacent building panels together as shown in FIG. 2. In particular, as shown in FIG. 2, the hook portion 32a of one panel can be bent over the hem portion 34a of the adjacent panel to form a seam that connects the panels together.

While hook portions 32a and hem portions 34a provide an effective means for joining two panels together, the present inventors have developed new configurations for joining panels that provide greater strength to the panels and increased resistance to corrosion.

### SUMMARY

The present inventors have developed novel configurations and approaches for connecting adjacent building panels made from sheet material that can enhance the strength of the panels and that can minimize sharp bends in the sheet material. The novel configurations and approaches may thereby reduce the potential for oxidation and corrosion. Another advantage is that seaming may be less likely to damage the building panels' coating because the novel connecting portions have a larger radius. According to an exemplary embodiment, a building panel formed from sheet material is described. The building panel extends in a longitudinal direction along its length and has a shape in cross section in a plane perpendicular to the longitudinal direction. The building panel includes a center portion in cross section, a first connecting portion connected at one side of the center portion, the first connecting portion comprising a loop in cross section, and a second connecting portion connected at an opposing side of the center portion, the second connecting portion comprising a hook in cross section, wherein the loop and the hook are complementary in size and shape for joining the building panel to adjacent building panels.

According to another exemplary embodiment, a building structure comprising a plurality of interconnected building panels is disclosed. Each building panel extends in a longitudinal direction along its length and has a shape in cross section in a plane perpendicular to the longitudinal direction. Each building panel includes a center portion in cross section, a first connecting portion connected at one side of the center portion, the first connecting portion comprising a loop in cross section, and a second connecting portion connected at an opposing side of the center portion, the second connecting portion comprising a hook in cross section, wherein the loop and the hook are complementary in shape for joining the building panel to adjacent building panels.

According to yet another exemplary embodiment, a system configured to form a flat sheet of material into a building panel is disclosed, where the building panel extends in a longitudinal direction along its length and has a shape in cross section in a plane perpendicular to the longitudinal direction. The system includes an entry guide adapted to receive a flat sheet of material, a first foiining assembly positioned adjacent to the entry guide, and a second forming assembly positioned adjacent to the first forming assembly, the first forming assembly including a first frame and multiple first rollers supported by the first frame, the multiple first rollers arranged to impact a flat sheet of material as the sheet passes along the multiple first rollers in the longitudinal direction such that the sheet is formed into a first shape in cross section, the second forming assembly including a second frame and multiple second rollers supported by the second frame, the multiple second rollers arranged to impact the sheet having the first shape as the sheet passes along the multiple second rollers in the longitudinal direction such that the sheet is formed into a second shape in cross section, the second shape having a first face and an opposite second face, and a pair of edges at the outermost ends of the second shape, and a drive system for moving the sheet longitudinally along the multiple first rollers and the multiple second rollers, wherein a subset of the multiple second rollers is arranged to bend one edge portion of the sheet in a curved manner in cross section so that the edge portion of the sheet comprises a loop, such that the second shape comprises a building panel having a first side portion and a second side portion extending from respective ends of a center portion in cross section, a first connecting portion extending from the first side portion, the first connecting portion comprising a loop in cross section, and a second connecting portion extending from the second side portion, the second connecting portion comprising a hook in cross section.

According to still another exemplary embodiment, a method of forming a flat sheet of material into a building panel is disclosed, where the building panel extends in a longitudinal direction along its length and has a shape in cross section in a plane perpendicular to the longitudinal direction. The method comprises receiving a flat sheet of material from a coil, driving the sheet longitudinally along multiple first rollers and multiple second rollers, impacting the sheet as the sheet passes along the multiple first rollers in the longitudinal direction such that the sheet is formed into a first shape in cross section, impacting the sheet having the first shape as the sheet passes along the multiple second rollers in the longitudinal direction such that the sheet is formed into a second shape in cross section, the second shape having a first face and an opposite second face, and a pair of edges at the outermost ends of the second shape, wherein a subset of the multiple second rollers is arranged to bend one edge portion of the sheet in a curved manner in cross section so that the edge portion of the sheet comprises a loop, such that the second shape comprises a building panel having a first side portion and a second side portion extending from respective ends of a center portion in cross section, a first connecting portion extending from the first side portion, the first connecting portion comprising a loop in cross section, and a second connecting portion extending from the second side portion, the second connecting portion comprising a hook in cross section.

### BRIEF DESCRIPTION OF THE DRAWINGS

These and other features, aspects, and advantages of the present disclosure will become better understood with regard to the following description, appended claims, and accompanying drawings.

FIG. 1 illustrates a cross sectional shape of a conventional building panel with a curved center portion.

FIG. 2 illustrates a conventional seam between two building panels for forming a building structure.

FIG. 3 illustrates an exemplary cross sectional shape of an exemplary building panel according to an exemplary aspect.

FIGS. 4a and 4b illustrate an exemplary connection between two exemplary building panels for forming a building structure according to an exemplary aspect.

FIGS. 5a and 5b illustrate an exemplary building panel with a hook and loop connecting portions before and after receiving a longitudinal curve along its length according to an exemplary aspect.

FIG. 6 illustrates an exemplary cross sectional shape of an exemplary building panel having a longitudinal curve along its length according to an exemplary aspect.

FIG. 7 illustrates an exemplary gable style building that can be formed using building panels described herein according to an exemplary aspect.

FIG. 8 illustrates an exemplary circular (or arch) style building that can be formed using building panels described herein according to an exemplary aspect.

FIG. 9 illustrates an exemplary double-radius (or two-radius) style building that can be formed using building panels described herein according to an exemplary aspect.

FIGS. 10a and 10b illustrate right and left side views, respectively, of an exemplary panel curving system according to an exemplary aspect.

FIGS. 11a and 11b illustrate magnified right and left side views, respectively, of a panel forming apparatus of the exemplary panel curving system of FIG. 10.

FIG. 12 illustrates a roller configuration of an exemplary panel forming apparatus that is in the process of forming a sheet of building material according to an exemplary aspect.

FIG. 13 illustrates an exemplary flower diagram showing the formation of a building panel according to an exemplary aspect.

FIGS. 14a and 14b illustrate right and left side views, respectively, of an exemplary panel curving apparatus according to an exemplary aspect.

FIGS. 15a and 15b illustrate a three dimensional isometric view of the exemplary curving assembly of FIGS. 14a and 14b from a right front and left front perspective according to an exemplary aspect.

FIG. 15c illustrates a left side view of the exemplary curving assembly of FIGS. 14a and 14b according to an exemplary aspect.

FIG. 16 illustrates an exemplary configuration of multiple rollers of the exemplary curving assembly of FIGS. 15a-15c according to an exemplary aspect.

FIG. 17a illustrates a top view of the exemplary panel curving apparatus of FIGS. 14a and 14b with a longitudinally straight panel inserted therein according to an exemplary aspect.

FIG. 17b illustrates another top view of the exemplary panel curving machine of FIGS. 14a and 14b with the building panel inserted and with relative rotation between first and second panel curving assemblies to promote longitudinal curving of the building panel.

FIG. 17c illustrates another top view of the exemplary panel curving machine of FIGS. 14a and 14b with the building panel inserted and relative rotation between second and third panel curving assemblies.

FIG. 17d is another top view of the exemplary panel curving machine of FIGS. 14a and 14b with the building panel inserted and relative rotation between third and fourth curving assemblies.

FIG. 17e is another top view of the exemplary panel curving machine of FIGS. 14a and 14b with the building panel inserted and relative rotation between fourth and fifth curving assemblies.

FIG. 17f is another top view of the exemplary panel curving machine of FIGS. 14a and 14b with the longitudinally curved portion of the building panel emerging from the outlet of the curving assemblies.

FIG. 18 illustrates an exemplary control system relative to other aspects of a panel curving system according to an exemplary aspect.

FIG. 19 illustrates an exemplary seaming device according to an exemplary aspect.

FIG. 20a illustrates rollers of an exemplary seaming device engaged with a seam prior to closing the seam according to an exemplary aspect.

FIG. 20b illustrates rollers of an exemplary seaming device engaged with a seam after closing the seam according to an exemplary aspect.

FIGS. 21a-21d illustrate exemplary cross sectional views of building panels having hook and loop seams according to exemplary aspects.

FIG. 22 illustrates a flow chart for an exemplary approach for making a panel of a desired shape according to an exemplary aspect.

### DETAILED DESCRIPTION OF EXEMPLARY EMBODIMENTS

An exemplary building panel as described herein includes complementary “hook” and “loop” connecting portions on opposite ends of the panel that can be mated with corresponding portions of adjacent building panels. As described herein, the “hook” connecting portion refers to a cross-sectional shape having an arcuate portion attached to an open end portion. The “loop” connecting portion refers to a cross-sectional shape that is substantially oval, elliptical, or circular in cross section, and is tubular in shape along the length of the building panel.

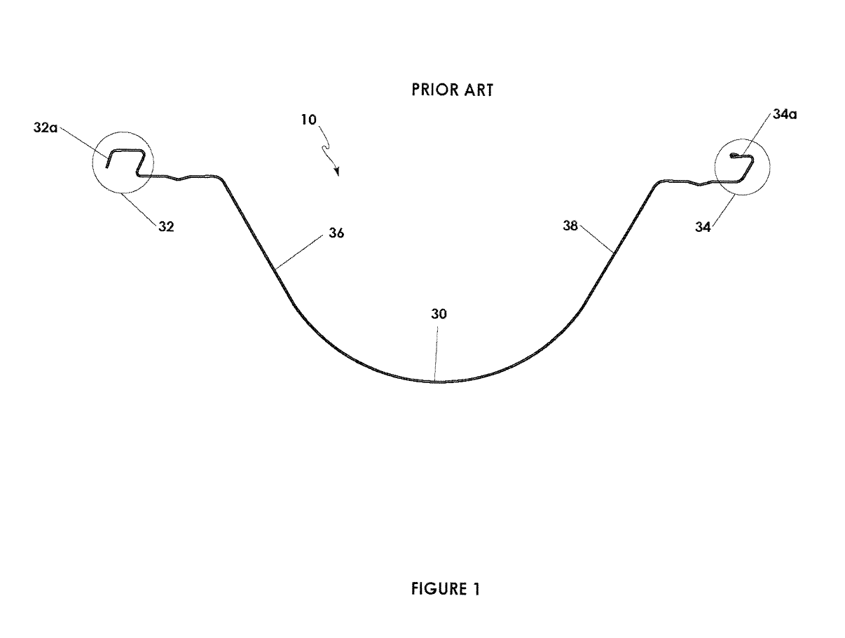

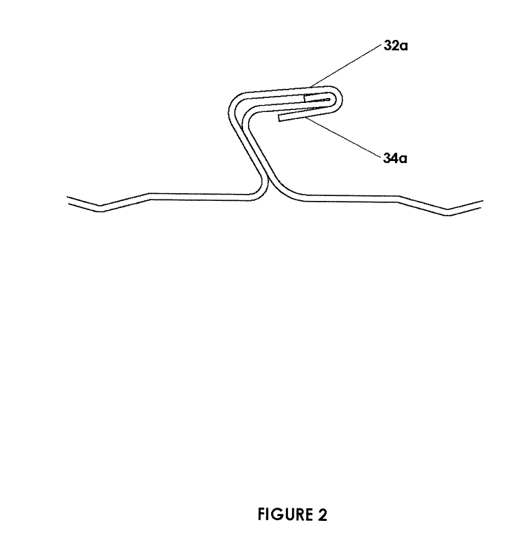

In comparison with building panels having conventional hook and hem connecting portions such as illustrated in FIGS. 1 and 2, for which the hook 32a undergoes a 180° bend with a tight bend radius over the hem 34a, building panels with hook and loop connecting portions according to exemplary embodiments of the present disclosure can be joined without creating a tight bend radius at the hem portion. Advantageously, the avoidance of a tight bend radius at the hem may allow organic coatings (e.g., paints) to remain undamaged when the panel is formed, thereby enhancing resistance to oxidation and corrosion of the panel at seams that join the panels together. In addition, closing of the hook around the loop during seaming may also be less likely to damage the coating because of the larger radius.

For example, the American Society for Testing and Materials (ASTM) provides a standard test method for measuring the flexibility of prepainted sheet materials (ASTM D 4145-83), which is incorporated herein by reference. The ASTM standard defines a T-bend as the severity of a bend in terms of thickness (T) of the sheet to which a coating has been applied. The T-bend rating according to this standard is therefore the minimum number of thicknesses of metal around which a coated sheet can be bent so as to achieve no fracture or removal of the coating. In other words, a 0T bend represents a sheet essentially bent back on itself, a 1T bend represents a sheet bent around a single thickness of its metal, etc. The difficulty and expense of manufacturing coatings is inversely proportional to the coating's T-bend rating, i.e., as the T-bend ratings get smaller, the cost of the coating will increase. Moreover, conventional coatings may not even be able to achieve T-bend ratings of 1T or 0T. Furthermore, conventional hem connecting portions as illustrated in FIGS. 1 and 2 typically have a 2T, 1T, or even 0T bend radius, which means that coatings on conventional hem connecting portions may frequently be subject to fracture and peeling. Hook and loop connecting portions according to exemplary embodiments, by contrast, typically have much greater than a 3T bend radius, and therefore coatings applied to these connecting portions are very likely to remain on the panel after forming, even when relatively inexpensive coatings are used.

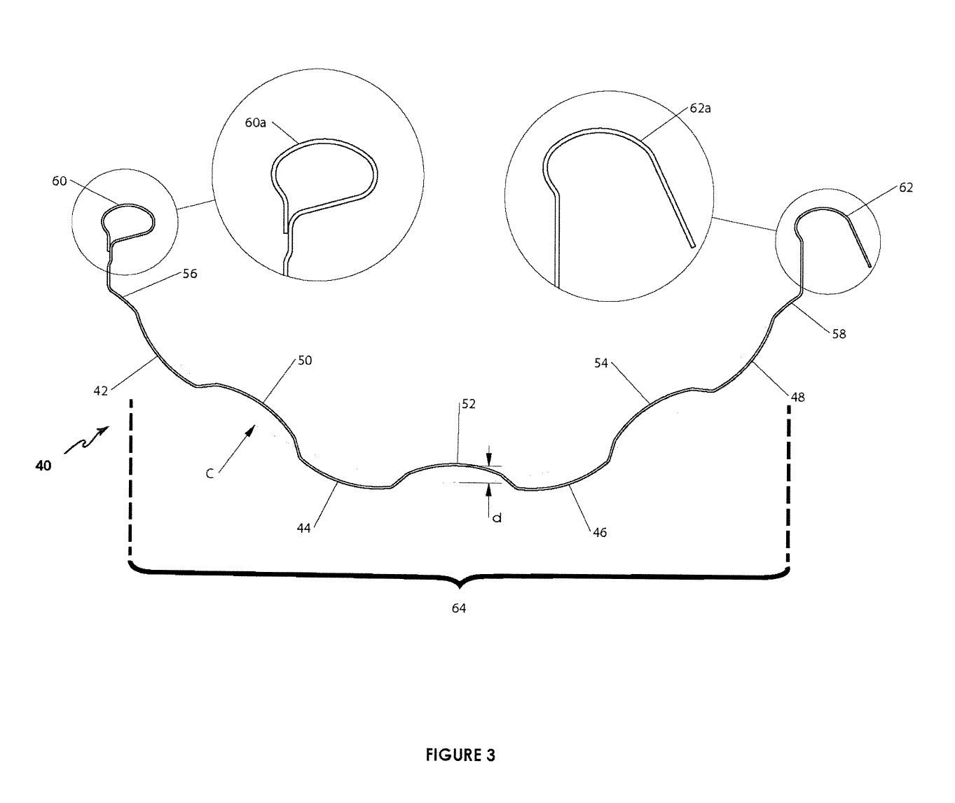

FIG. 3 shows an exemplary building panel according to the present disclosure in cross section having hook and loop connecting portions. As illustrated in FIG. 3, the building panel 40 includes a curved center portion 64, a pair of side portions 56 and 58 extending from the curved center portion 64 in cross section, and a pair of connecting portions 60 and 62 extending from the side portions 56 and 58, respectively, in cross section. The overall outline of the curved center portion 64 is illustrated by the curved dotted line C. Connecting portion 60 includes a loop portion 60a, and connecting portion 62 includes a hook portion 62a as illustrated in FIG. 3, where the hook portion 60a and the loop portion 62a are complementary in size and shape for joining the building panel to adjacent building panels. The loop portion 60a forms a tubular structure along the length of the panel in the longitudinal direction out of the plane of the paper. The hook portion 62a is sized and shaped so that it can fit snugly over the loop portion 60a of an adjacent building panel, as will be described further herein.

The building panel 40 is formed from sheet material, such as, for example, structural steel sheet metal ranging from about 0.035 inches to about 0.080 inches in thickness. The building panel 40 can be formed from other sheet materials as well, such as other types of steel, galvalume, zincalume, aluminum, or other building material that is suitable for construction. The thickness of the building panel 40 may generally range from about 0.035 inches to about 0.080 inches (±10%), depending upon the type of sheet material used. Of course, the building panel 40 may be formed using other thicknesses and using other sheet building materials as long as the sheet materials possess suitable engineering properties of strength, toughness, workability, etc. For example, using structural sheet metal having a thickness in the range of about 0.035 inches to about 0.080 inches, the width of the panel 40 between the connecting portions 60 and 62 may be in the range of about 12-30 inches (straight line distance), and the width of the tubular loop portion 60a in cross section may be in the range of about ½ to 2 inches. The size and shape of the hook portion 62a is commensurate with that of the loop portion 60a so that the hook portion 62a may fit snugly over the loop portion 60a.

As shown in FIG. 3, the building panel 40 also includes a plurality of segments 42, 44, 46, 48, 50, 52, and 54. These segments extend in the longitudinal direction along the length of the building panel 40. These segments may also be referred to as longitudinal deformations, longitudinal ribs, stiffening ribs, and the like, and serve to strengthen the building panel 40 against buckling and bending under loads. In this example, segments 42, 44, 46, and 48 extend outwardly in cross section, and segments 50, 52, and 54 extend inwardly in cross section. For reference purposes, “inward” as used herein means closer to a geometric center of the cross section of a building panel, and “outward” means farther from the geometric center of the cross section of a building panel. As shown in FIG. 3, adjacent segments extend in opposing directions (e.g., segment 52 extends inwardly whereas adjacent segment 44 extends outwardly). In the example of FIG. 3, the depth of a given segment relative to the adjacent segments is a depth d. The depths of the segments of the straight building panel may all be the same, as illustrated in the example of FIG. 3, or the depths of the segments may differ from one another.

The exemplary straight building panel 40 illustrated in FIG. 3 includes three inwardly extending segments (50, 52, and 54) and four outwardly segments (42, 44, 46, and 48), but other numbers of outwardly extending segments and inwardly extending segments may be used. For example, the number of outwardly extending segments could be greater or less than the number of inwardly extending segments. Various sizes and number combinations of segments may be used depending upon the cross sectional shape desired in the building panel.

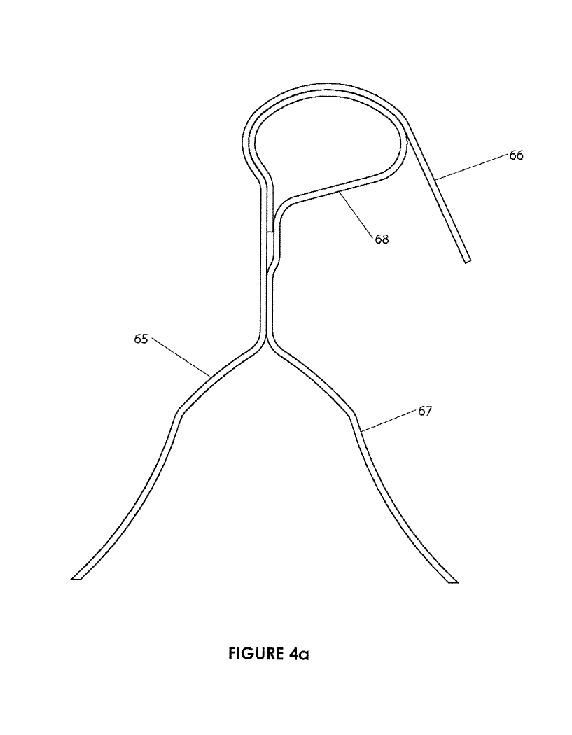

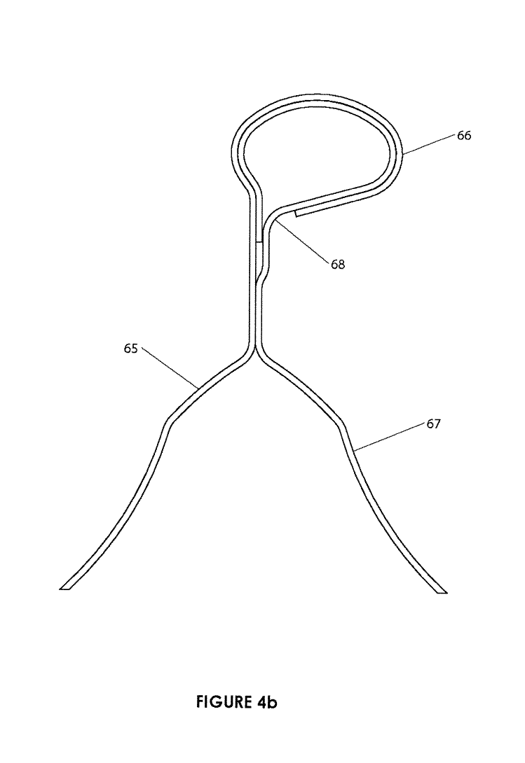

In certain embodiments, the loop may be formed so that it can be brought into a resiliently biased engagement with the hook of an adjacent building panel. In other words, the hook of one panel may snap tightly onto the loop of an adjacent panel, thereby providing a secure connection. FIG. 4a illustrates an exemplary junction of the hook 66 of an exemplary first panel 65 in resiliently biased engagement with the complementary loop 68 of an adjacent second panel 67. In this exemplary embodiment, the shape of the loop 68 retains the hook 66 in position until a permanent seam can be formed. Those of skill in the art will appreciate that such permanent seams can be formed using seaming devices such as described elsewhere herein. In the example of FIG. 4b, the hook 66 is crimped over the loop 68 to provide a secure seam.

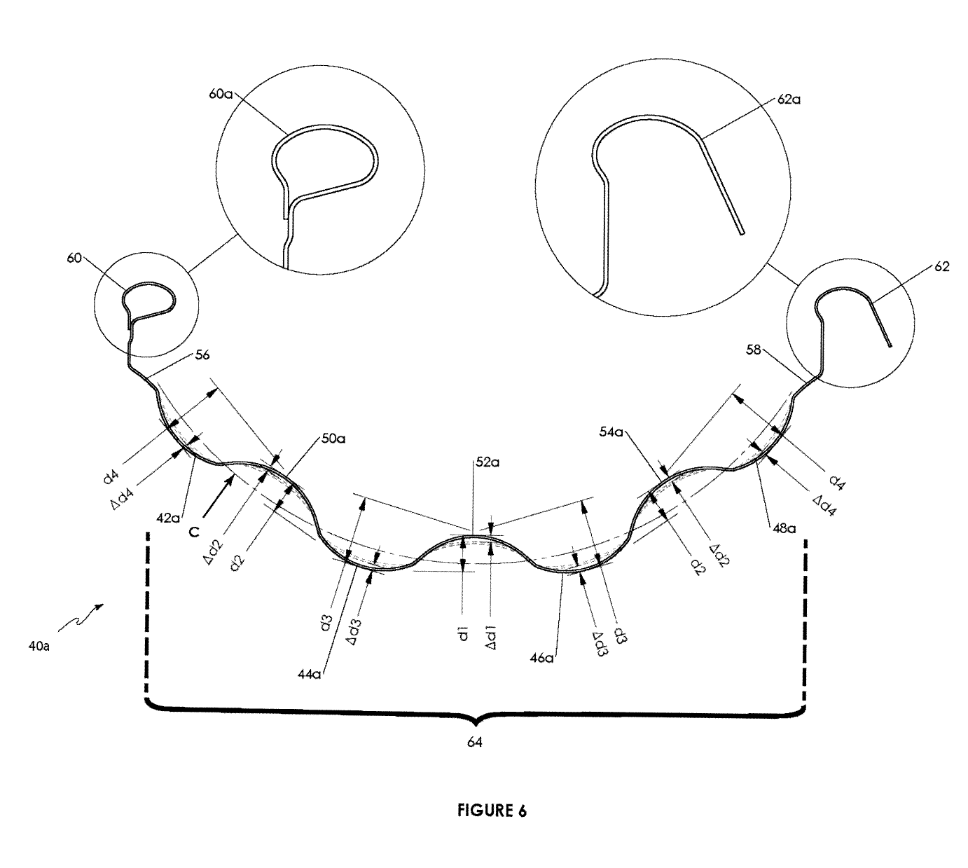

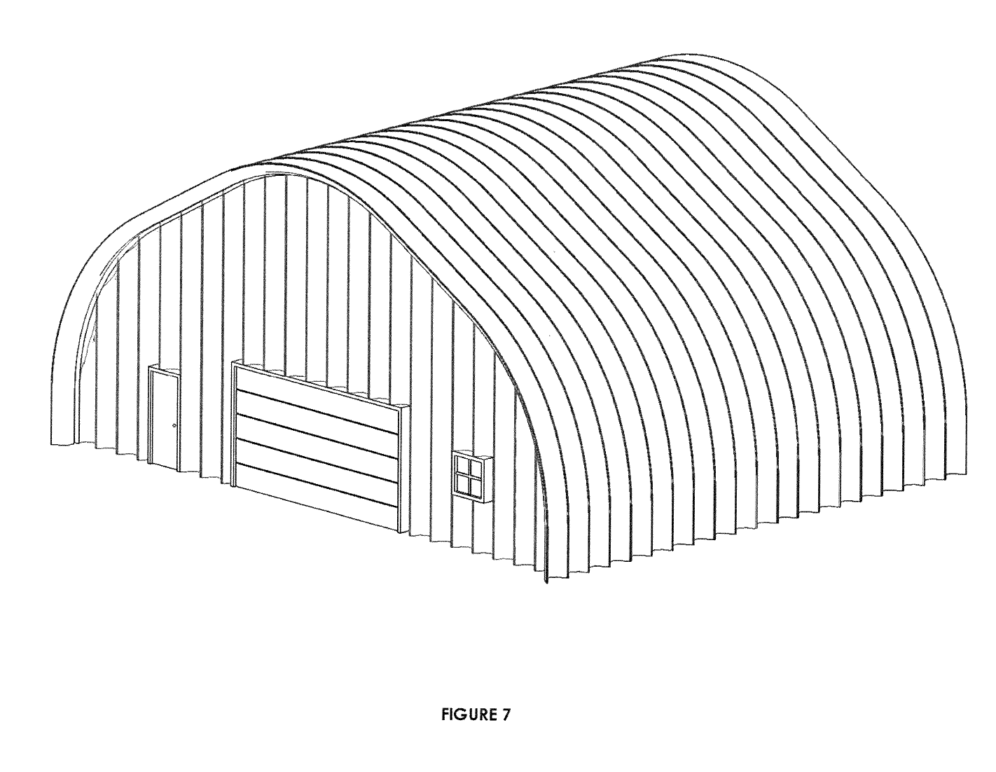

Advantageously, interconnecting panels with hook and loop connections according to exemplary embodiments can provide the panels with additional structural integrity and resistance to bending moments. For example, the present inventors have determined by performing simulations using American Iron and Steel Institute compliant cold-formed steel analysis software that the building panel 40 shown in FIG. 6 may have an increased strength to resist positive and negative moments by as much as 15% as compared to a similar building panel using a standard hook 32a and hem 34a such as shown in FIG. 1. The inventors' determination that the novel hook and loop configuration according to exemplary embodiments of the present disclosure can significantly increase the strength of building panels is an unexpected and surprising result.

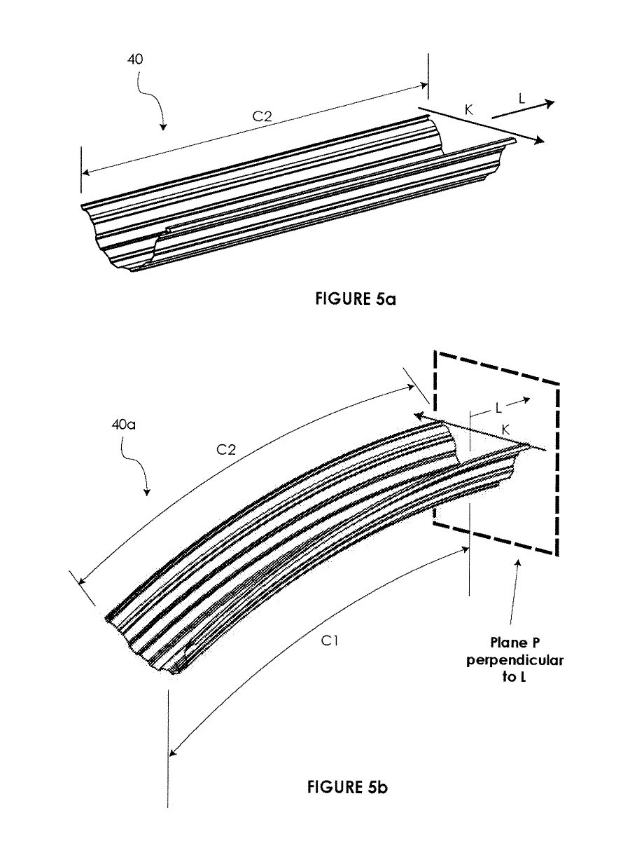

Building panels may be curved longitudinally to form a variety of building structures (as described below). FIG. 5a illustrates an exemplary straight building panel 40 that can be curved along a longitudinal direction L to form an exemplary curved building panel 40a as shown in FIG. 5b. As described herein, the longitudinally curved building panel 40a can be formed by a process that includes applying a torque to the building panel and/or forcibly deforming longitudinally extending segments to change the cross sectional shape of the building panel as described below.

The building panels 40 and 40a extend in a longitudinal direction along their lengths. For straight building panel 40, the longitudinal direction L is parallel to the length of the building panel. The building panel 40a is curved along its length, and the longitudinal direction in that case is tangential to the lengthwise curve of the building panel 40a at any particular location on the building panel 40a. The building panel 40a is curved in the longitudinal direction without having transverse corrugations therein.

The straight building panel 40 and the curved building panel 40a have a curved shape in cross section in a plane perpendicular to the longitudinal direction L. An exemplary plane P and longitudinal direction L at one end of the building panel 40a are illustrated in FIG. 5b. In the illustration of FIG. 5a, the straight building panel 40 has a linear length C2. The longitudinally curved building panel 40a derived from panel 40, however, has shorter linear length C1 a lower portion thereof compared to a linear length C2 at an upper portion thereof because the bottom portion at C1 is effectively shortened due to the longitudinal curving. In other words, the linear length of the building panel 40 is not shortened in the longitudinal direction at the regions of the connecting portions 60 and 62. The terminology upper and lower are used simply for convenience in connection with the orientations illustrated in FIGS. 5a and 5b, and are not intended to be limiting in any way.

FIG. 6 shows the cross sectional shape of the building panel 40a in cross section, e.g., at plane P shown in FIG. 5b, following a longitudinal curving process (described below). The cross sectional shape of the straight building panel 40, i.e. before the longitudinal curving process, is shown in FIG. 6 as a dashed profile for illustrative purposes. As illustrated in FIG. 6, the building panel 40a includes a curved center portion 64, a pair of side portions 56 and 58 extending from the curved center portion 64 in cross section, and a pair of connecting portions 60 and 62 extending from the side portions 56 and 58, respectively, in cross section, similar to that of straight building panel 40. These connecting portions 60 and 62 include a loop 60a and a hook 62a as previously described. The overall outline of the curved center portion 64 is illustrated by the curved dotted line C. The curved center portion may have a semi-circular shape or other arcuate shape.

As a result of the curving process, however, the cross-sectional profile of the segments undergoes changes. In particular, since the straight building panel 40 possessed segments of uniform depth d as shown in FIG. 3, various segments of curved building panel 40a will have different overall depths after longitudinal curving. The exemplary longitudinally curved building panel 40a includes inwardly extending segments 50a, 52a, and 54a, and outwardly extending segments 42a, 44a, 46a, and 48a. As illustrated in FIG. 6, due to longitudinal curving, a particular segment of the longitudinally curved building panel 40a will have undergone a change in depth greater than that of another segment. In the example of FIG. 6, the depth of segment 52a changes inwardly in cross section by an amount Δd1, and the depth of neighboring segments 50a and 54a change inwardly by an amount Δd2, wherein Δd1 is greater than Δd2. Similarly, the depth of segments 44a and 46a change outwardly in cross section by an amount Δd3, and the depth of neighboring segments 42a and 48a change outwardly by an amount Δd4, wherein Δd3 is greater than Δd4. Segment 52a is positioned at a middle of the curved center portion 64 and has the greatest change in depth of any of the segments illustrated in the example of FIG. 6.

In view of the explanation above, it will be appreciated that to achieve a longitudinally curved building panel segments all having approximately the same depth according to the present disclosure, a straight building panel having non-uniform segment depths to start with would be needed (e.g., a straight building panel with shallower segments near the middle thereof and deeper segments near the edges thereof would be needed). The identification of appropriate starting segment depths of such a straight building panel is within the purview of one of ordinary skill in the art, e.g., by limited trial-and-error testing, in view of the information provided herein.

As discussed in more detail elsewhere herein, as the straight building panel 40 illustrated in cross section in FIG. 3 is curved longitudinally into building panel 40a illustrated in cross section in FIG. 6, the depths of various segments change to accommodate the formation of the longitudinal curve. The greater change in depth Δd1 relative to the change in depth Δd2 accommodates the formation of the longitudinal curve in the building panel 40a by permitting the accumulation of sheet material into segment 52a in connection with a lengthwise shortening of the building panel 40a at that location during longitudinal curving compared to other locations on the building panel 40a that exhibit less lengthwise shortening. Similarly, the greater change in depth Δd3 relative to the change in depth Δd4 also accommodates the formation of the longitudinal curve in the building panel 40a by permitting the accumulation of sheet material into segments 44a and 46a in connection with a lengthwise shortening of the building panel 40a at that location during longitudinal curving compared to other locations on the building panel 40a that exhibit less lengthwise shortening. The lengthwise shortening of the building panel 40a near segment 52a is illustrated by the relatively shorter length C1 of the building panel 40a at that (lower) location as compared to the longer length C2 of the building panel at the (upper) regions of the connecting portions 60 and 62, as shown in FIG. 5b.

As noted above, the difference between linear lengths C1 and C2 occurs because the longitudinally curved building panel 40a is derived from a straight building panel 40 having a similar cross sectional shape and a uniform length. In the longitudinal curving process described herein, the depths of various segments change to accommodate the longitudinal curve in the building panel 40a without the need to impart transverse corrugations into the building panel 40a. Greater degrees of longitudinal curving, corresponding to smaller radii of curvature, are accompanied by greater changes in the depths of segments. Segments located at areas of relatively greater linear shorting of the panel due to the longitudinal curving exhibit relatively greater changes in depth.

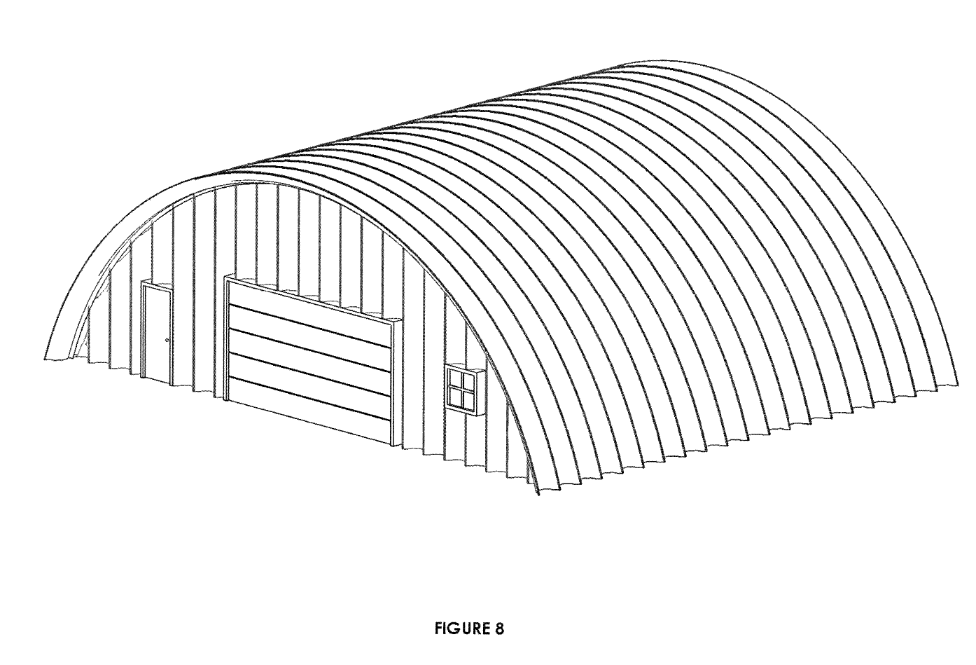

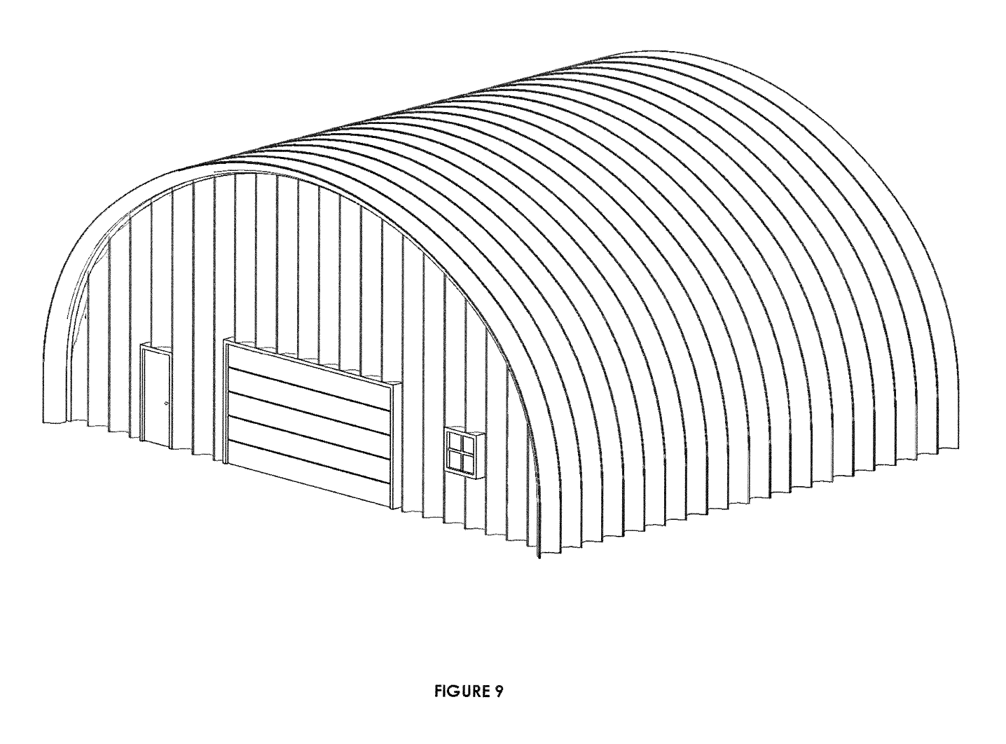

Building panels such as illustrated in FIGS. 3 to 6 and as described herein may be used to construct exemplary building structure of various shapes by connecting a loop 60a of one building panel to a hook 62a of an adjacent building panel. FIGS. 7-9 illustrate exemplary shapes of buildings that can be manufactured using building panels as described herein. These exemplary building shapes include gable style buildings, an example of which is shown in FIG. 7, circular style buildings, an example of which is shown in FIG. 8, and double-radius (or two-radius) style buildings, an example of which is shown in the example of FIG. 9. In the exemplary buildings illustrated in FIGS. 7-9, longitudinally curved building panels are used to form the roof sections, and straight panels are used to construct the flat end wall sections. Other shapes can also be fabricated, such as “lean to” buildings which are taller at one side than another side, gable or two-radius buildings with angled side walls, and other variations using combinations of building panels having longitudinally curved portions of various radii and building panels having straight portions.

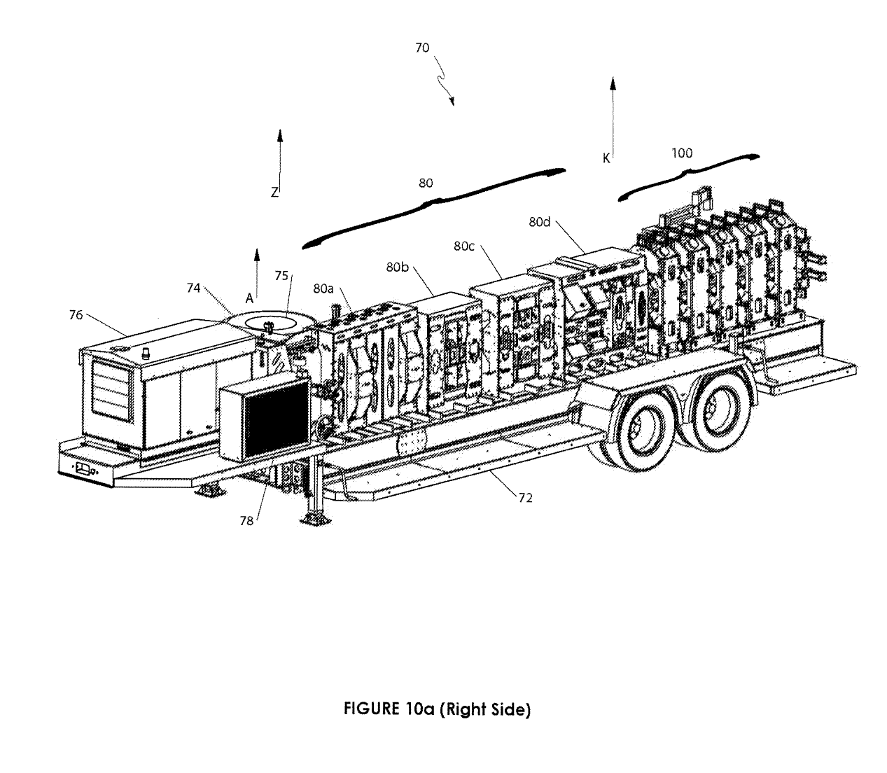

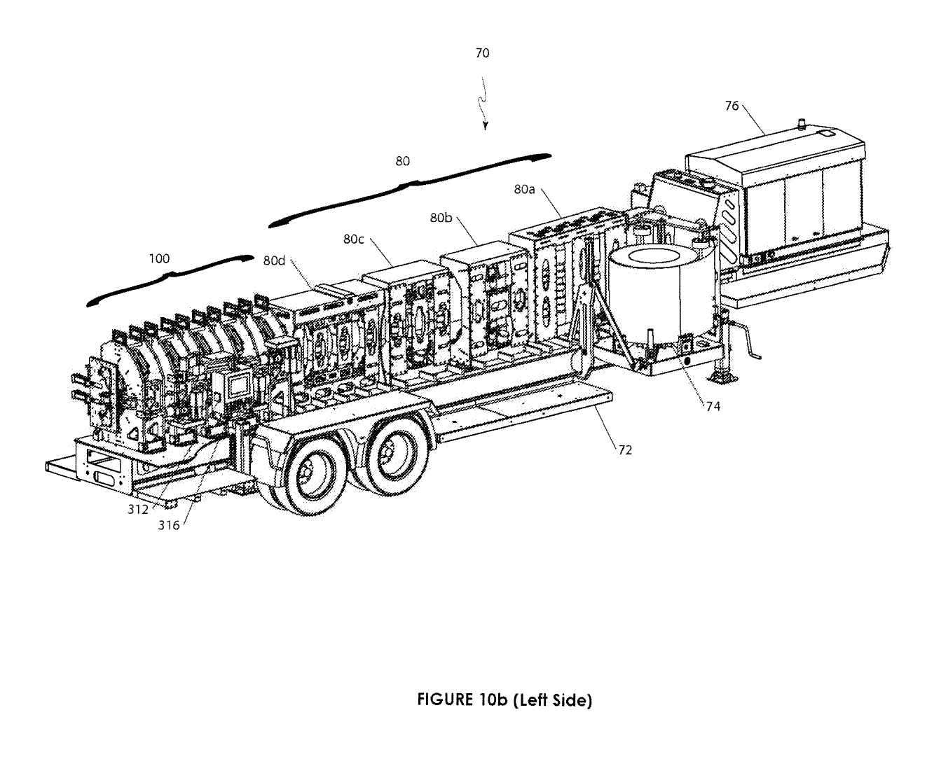

An exemplary system for manufacturing building panels of the types described herein will now be described. An exemplary panel forming and curving system 70 is illustrated in FIGS. 10a and 10b (right side view and left side view, respectively). The system 70 includes a support structure 72, shown in this example as a mobile trailer platform that can be towed behind a truck so that the system 70 can be easily transported to a job site. Supported by the support structure 72 is a coil holder 74 (decoiler) for supporting a coil 75 of sheet material (e.g., steel sheet metal). The coil holder 74 permits the coil 75 to rotate about an axis A parallel to the vertical direction Z such that the sheet material can be fed into the panel forming apparatus 80. The coil holder 74 may include any suitable mechanism (e.g., an idler that pushes against a radial surface of the coil 75) to prevent uncontrolled unraveling of the coil 75. It will be appreciated that the coil holder 74 can be placed in any desired location suitable for feeding sheet material from the coil 75, and its position is not limited to the position illustrated in FIG. 10a and FIG. 10b. A power supply 76, e.g., a diesel engine, is also provided to power the various functions of the system 70. A hydraulic heat exchanger 78 may be mounted on the support structure 72 to provide cooling for the hydraulic systems. A control system may also be provided, such as an operator control console 312 (e.g., computer such as a personal computer) and a man-machine interface 316, such as a touch-sensitive display screen, as described in more detail elsewhere herein.

Also supported by the support structure 72 is a panel forming apparatus 80 that includes multiple panel forming assemblies 80a-80d that are configured to generate a building panel that is straight along its length and that has a desired cross sectional shape. The system 70 also includes a panel curving apparatus 100 that includes multiple curving assemblies 102, 104, 106, 108, and 110. The panel curving assemblies 102, 104, 106, 108, and 110, under the control of a control system 300 (e.g., a manual control system or a microprocessor-based programmable logic controller), are configured to receive the straight building panel 40, such as illustrated, for example, in FIG. 3. The panel curving apparatus 100 then imparts a longitudinal curve to that building panel and outputs a longitudinally curved building panel 40a, such as illustrated, for example, in FIG. 5b.

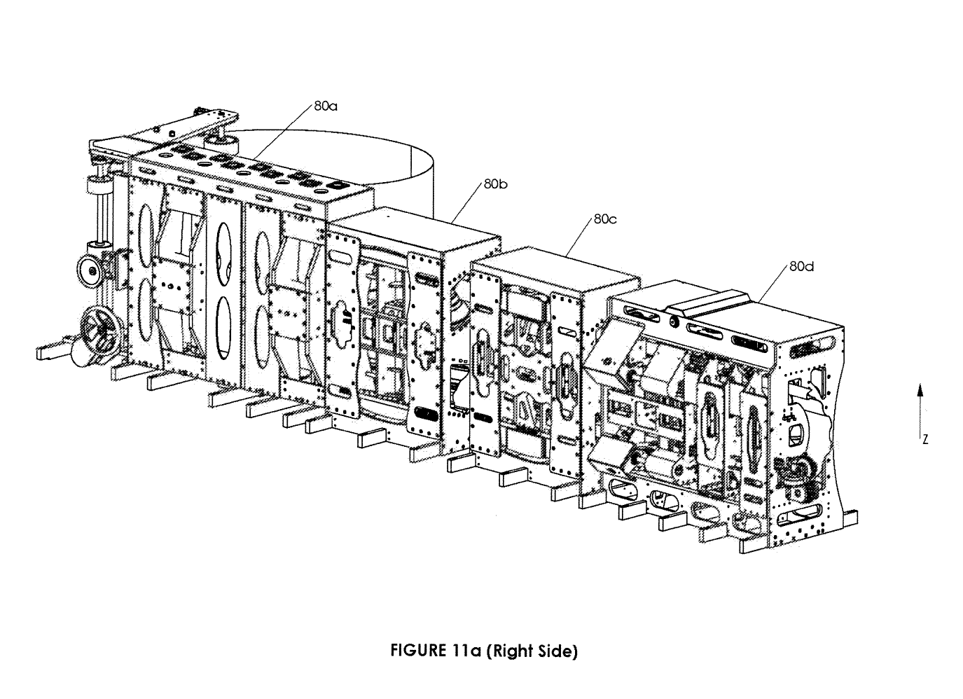

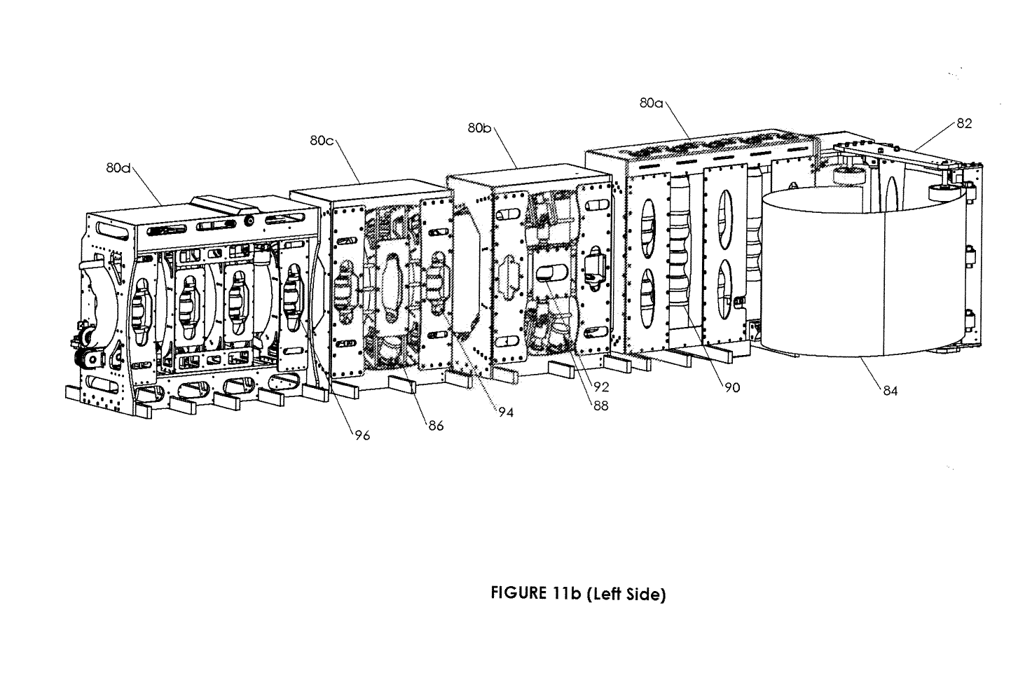

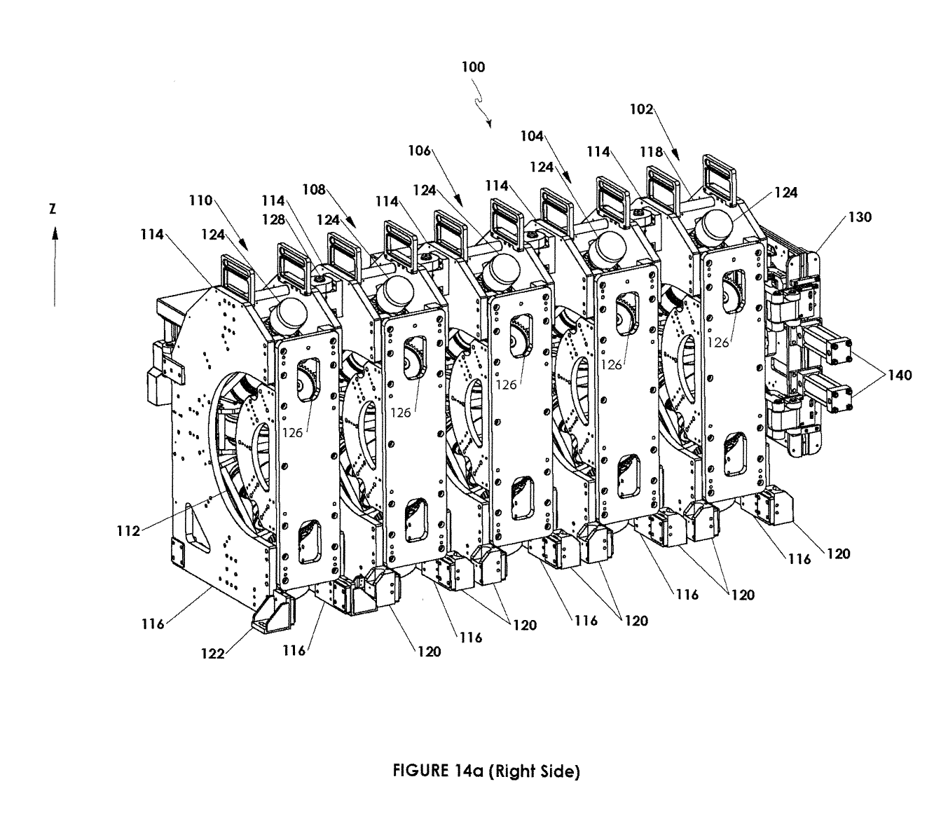

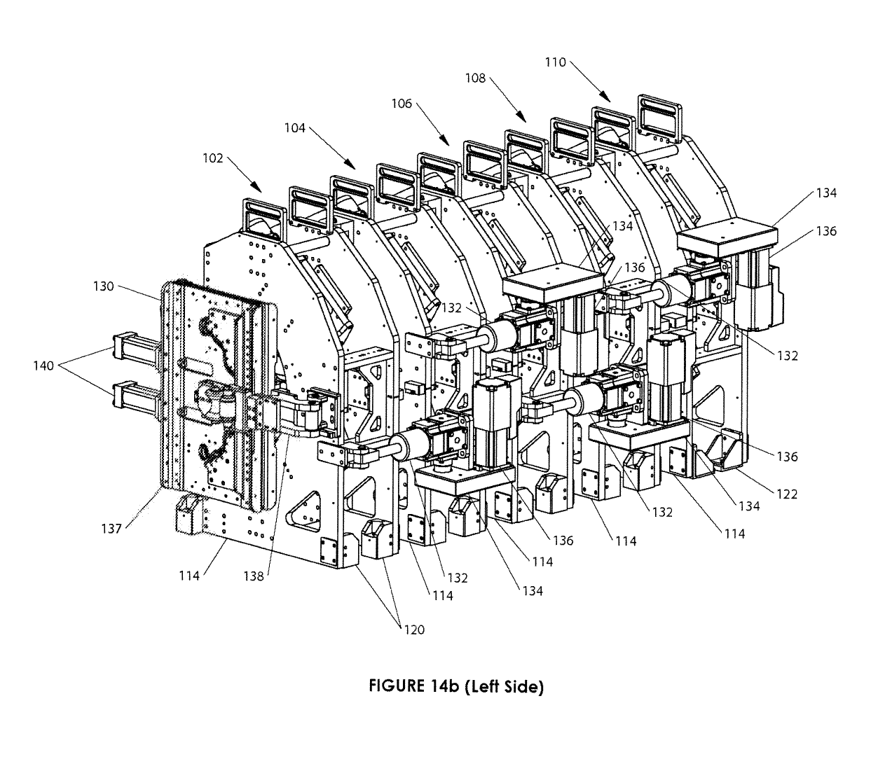

In the exemplary configuration shown in FIGS. 10a and 10b, the direction K of panels 40 and 40a shown in FIG. 5a is aligned with the vertical direction Z illustrated in FIG. 10a. This is also shown in FIGS. 11a and 14a, which illustrate portions of the panel forming apparatus 80 and panel curving apparatus 100 at greater magnification. Thus, in this exemplary configuration, the coil holder 74, the panel forming assemblies 80a-80d, and the curving assemblies 102, 104, 106, 108, and 110 are all oriented vertically, so that from the time the straight building panel 40 is initially formed by the panel forming apparatus 80 through the time the longitudinally curved building panel 40a exits the panel curving apparatus 100, the direction K of the building panels 40 and 40a will be aligned with the vertical direction Z. Such a configuration results in a “one step” process insofar as a straight building panel 40 does not have to be removed from a panel forming apparatus located at one location and then transported to a panel curving apparatus at another location for longitudinal curving.

While in the example illustrated in FIGS. 10a and 10b the coil holder 74, the panel forming apparatus 80, and the panel curving apparatus 100 are all illustrated as being oriented vertically, use of a common vertical orientation for these apparatuses is not required. For example, the panel forming apparatus 80 and a suitable coil holder could be oriented horizontally, i.e., at an angle of 90 degrees relative to the orientations shown in FIGS. 10a and 10b. The horizontal coil holder could be located proximate the horizontally oriented panel forming apparatus 80, e.g., co-located on a common support structure (e.g., mobile trailer platform) so that sheet material from the coil is fed into the panel forming apparatus. Then, in a “two step” process, a longitudinally straight building panel 40 could be generated and removed from the panel forming apparatus 80 in a first step, and then, in a second step, the straight building panel 40 could be transported to and fed into a vertically oriented panel curving apparatus located on a different support structure.

Exemplary embodiments of the panel forming apparatus will now be described. FIGS. 11a and 11b illustrate the panel forming apparatus 80 in more detail. An entry guide 82 is positioned at an entrance side of the panel forming apparatus 80 proximate the decoiler 74 to receive a flat sheet of material 84 from the coil 75. The entry guide 82 guides the sheet of building material 84 into the first panel forming assembly 80a by way of a set of rollers mounted to a frame supported on the structure 72. Each panel forming assembly 80a-80d also includes a plurality of rollers supported by a respective frame, wherein the rollers of each successive panel forming assembly 80a-80d are configured to incrementally impart additional shape to the longitudinally straight building panel that is being formed.

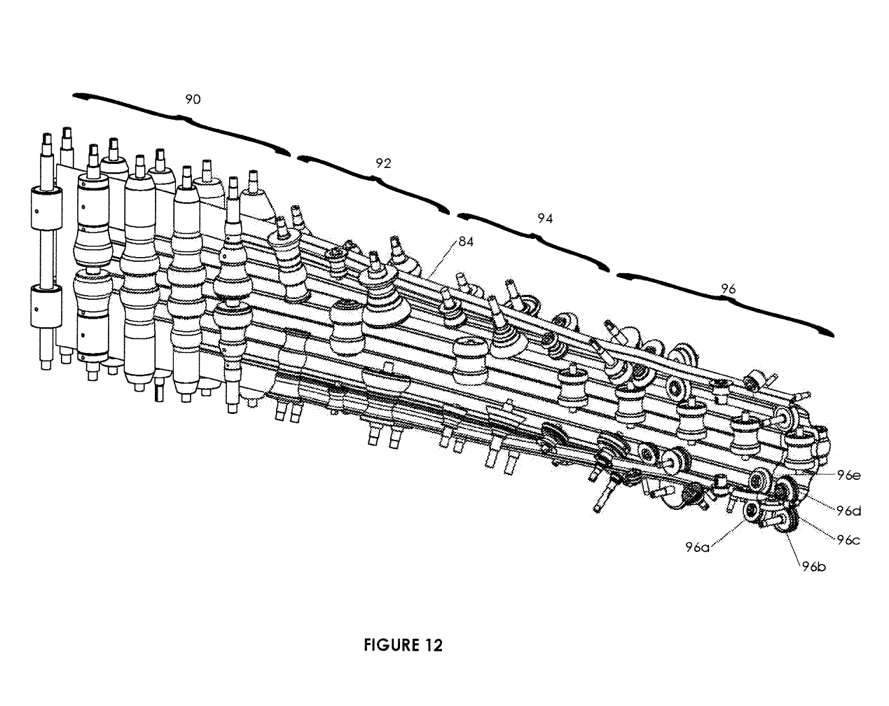

FIG. 12 illustrates how the rollers of the panel forming apparatus 80 may be configured to form a sheet of building material 84 into a straight building panel having a cross sectional shape such as that of building panel 40 illustrated in cross section in FIG. 3. The set of rollers 90 of panel forming assembly 80a are situated proximate the entry guide 82 to accept a flat sheet of building material. The sets of rollers 92, 94, and 96 for panel forming assemblies 80b, 80c, and 80d, respectively, successively form the building panel shown in FIG. 3. In particular, for example, a subset 96a, 96b, 96c, 96d, and 96e of rollers of the panel forming assembly 80d is arranged such that one edge of the sheet 84 is formed to extend in a circular form back into contact with the outside face of the sheet in cross section so that an end portion of the sheet defines a loop 60a as shown in FIG. 3. The panel forming assemblies 80a-80d of panel forming apparatus 80 can be driven by hydraulic motors, for example, powered by power supply 76, and can be controlled with a programmable logic controller using approaches and designs known to those of skill in the art.

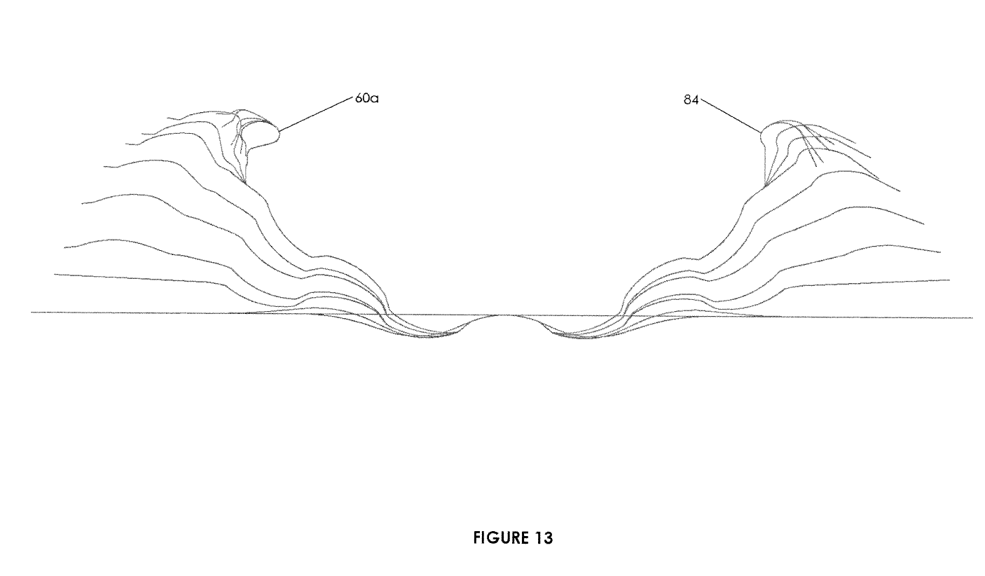

FIG. 13 illustrates an exemplary flower diagram demonstrating how the rollers of the panel forming apparatus 80 can form sheet material 84 into the building panel 40 shown in FIG. 3. As shown, the end of the sheet 84 that becomes a loop 60a is successively formed to curve outward by bending the end back through approximately a 180° arc to come into contact with the exterior edge of the sheet 84. Advantageously, the present inventors have found that bending the sheet 84 outward in the manner shown in FIG. 13, rather than attempting to bend the end of the sheet inward through a 360° arc, places less stress on the sheet 84 and the rollers 90, 92, 94, and 96, thereby resulting in a lower rate of slippage of the sheet 84 during panel forming.

Exemplary embodiments of the panel curving apparatus will now be described. The first exemplary embodiment may be thought of as relating to a passive deformation approach insofar as certain rollers are positioned with gaps therebetween to accommodate the accumulation of sheet material of the building panel as the longitudinal curve is formed in the building panel. The second exemplary embodiment briefly described below may be thought of as relating to an active deformation approach insofar as certain rollers of the panel curving apparatus are themselves positioned so as to forcefully deform and increase the depths of certain segments of the building panel to facilitate longitudinal curving of the building panel. However, it should be appreciated that in light of the teachings herein the “active” approach and the “passive” approach need not be considered mutually exclusive, and variations on these curving approaches may incorporate aspects of both approaches.

As discussed in more detail elsewhere herein, as the straight building panel 40 is curved longitudinally into building panel 40a illustrated in cross section in FIG. 6, the depths of various segments change to accommodate the formation of the longitudinal curve. The greater change in depth Δd1 relative to the change in depth Δd2 accommodates the formation of the longitudinal curve in the building panel 40a by permitting the accumulation of sheet material into segment 52a in connection with a lengthwise shortening of the building panel 40a at that location during longitudinal curving compared to other locations on the building panel 40a that exhibit less lengthwise shortening. Similarly, the greater change in depth Δd3 relative to the change in depth Δd4 also accommodates the formation of the longitudinal curve in the building panel 40a by permitting the accumulation of sheet material into segments 44a and 46a in connection with a lengthwise shortening of the building panel 40a at that location during longitudinal curving compared to other locations on the building panel 40a that exhibit less lengthwise shortening.

As noted above, the difference between linear lengths C1 and C2 occurs because the longitudinally curved building panel 40a is derived from a straight building panel 40 having a similar cross sectional shape and a uniform length. In the longitudinal curving process described herein, the depths of various segments change to accommodate the longitudinal curve in the building panel 40a without the need to impart transverse corrugations into the building panel 40a. Greater degrees of longitudinal curving, corresponding to smaller radii of curvature, are accompanied by greater changes in the depths of segments. Segments located at areas of relatively greater linear shorting of the panel due to the longitudinal curving exhibit relatively greater changes in depth. An exemplary curving apparatus employing a passive approach for generating the panel illustrated in FIG. 6 will now be described.

FIGS. 14a and 14b illustrate right and left side views, respectively, of an exemplary panel curving apparatus 100 according to an exemplary embodiment. The panel curving apparatus 100 includes a first curving assembly 110 at an entrance side of the apparatus 100, a second curving assembly 108 positioned adjacent to the first curving assembly 110, a third curving assembly 106 positioned adjacent to the second curving assembly 108, and a fourth curving assembly 104 positioned adjacent the third curving assembly 106. A fifth curving assembly 102 is located at an exit side of the apparatus 100 and positioned adjacent to the fourth curving assembly 104. Additional curving assemblies could be added to provide even greater control of the curving process with the potential benefit of achieving smaller radii of curvature. Moreover, while the use of five panel curving assemblies in the panel curving apparatus 100 has been found to be advantageous, more or less than five panel curving assemblies could be used if desired.

The panel forming apparatus 80 may feed the straight building panel 40 directly into the panel curving apparatus 100. Alternatively, an entry guide (not shown) may be positioned at an entrance side of the panel curving apparatus 100 and adjacent to the first curving assembly 110 to guide a straight building panel into the panel curving apparatus 100. As noted above, the straight building panel that is entering the panel curving apparatus 100 has a shape in cross section in a plane perpendicular to the longitudinal direction that includes a curved center portion 64, a pair of side portions 56 and 58 extending from the curved center portion, and a pair of connecting portions 60 and 62 extending from the side portions, where the connecting portions include a loop 60a and a hook 62a respectively.

As shown in FIGS. 14a and 14b, the curving assemblies 102, 104, 106, 108, and 110 each include a frame 114. The frames 114 of curving assemblies 102, 104, 106, 108, and 110 include a pair of plates 116 and various cross members 118 that join the plates 116 of any given curving assembly 102, 104, 106, 108, and 110 together. The plates 116 and cross members 118 may be made from 0.75 inch thick steel, or other strong material, for example. The plates 116 provide a structure for various components of the assemblies 102, 104, 106, 108, and 110 to be mounted and provide for a rigid frame. The exemplary configuration of frame 114 shown in FIGS. 14a and 14b has been found to be advantageous, but a suitable frame for the panel curving apparatus 100 is not limited to any particular configuration.

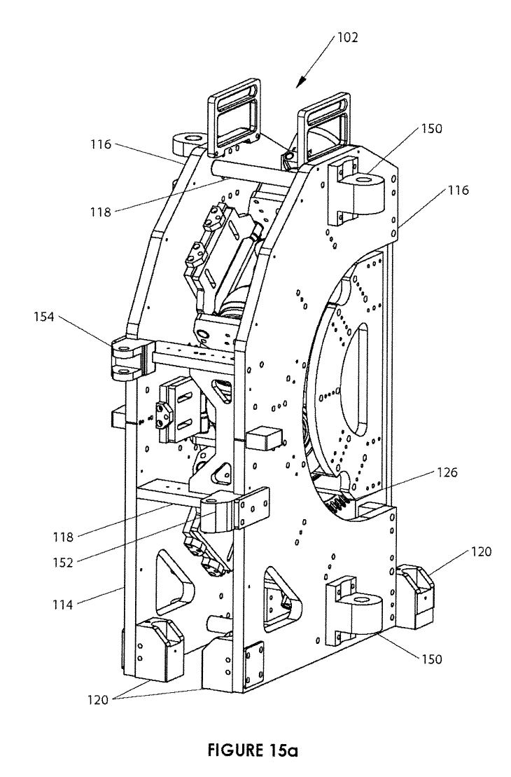

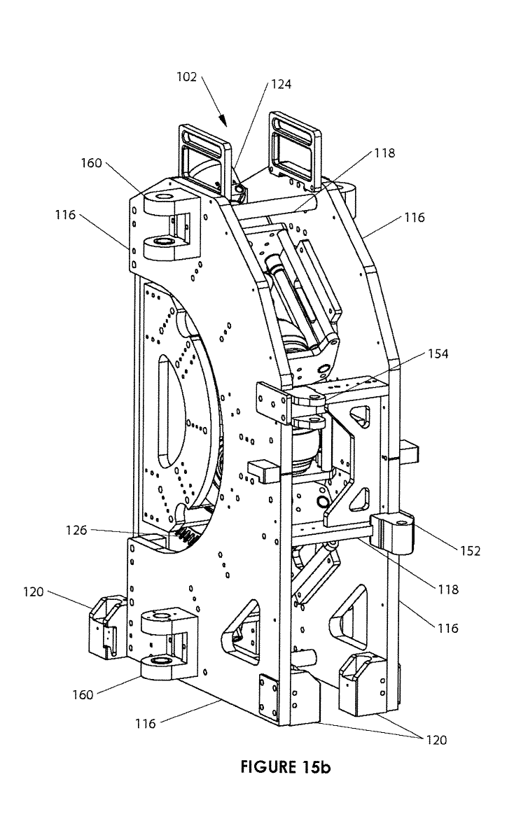

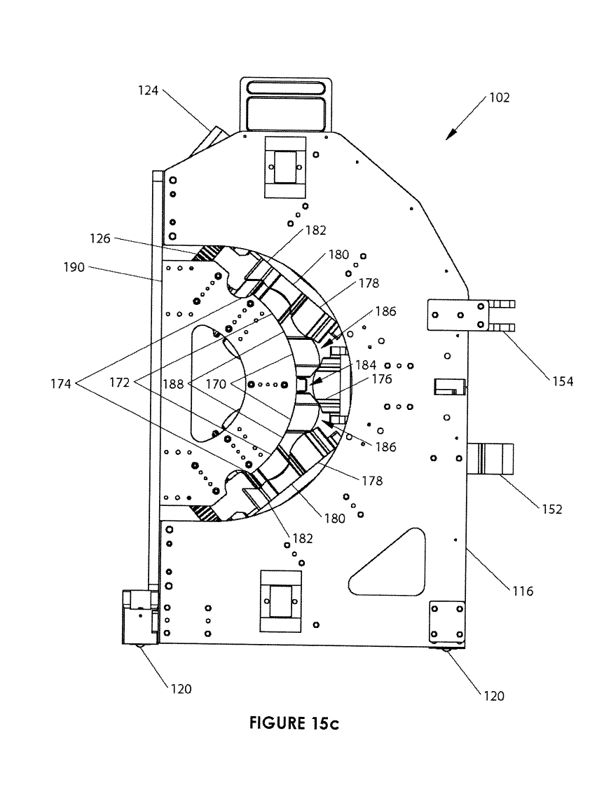

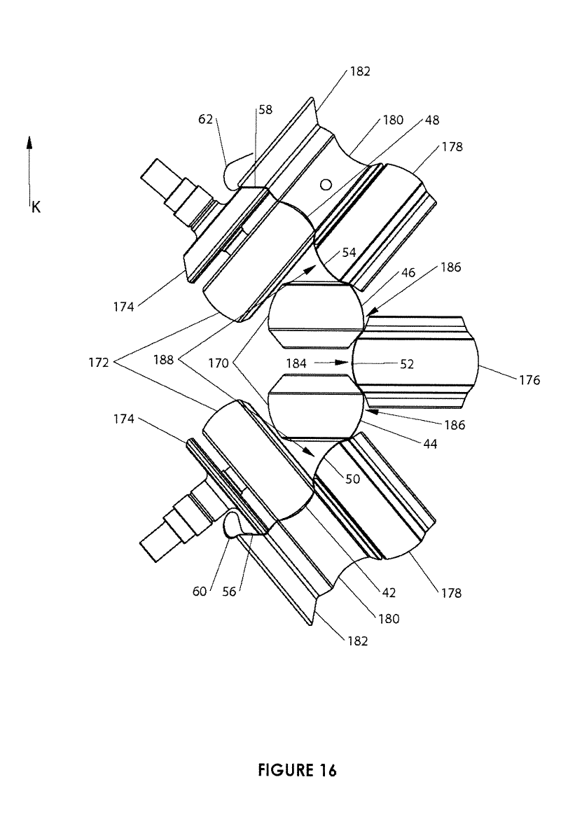

FIG. 15a shows a right side perspective view of curving assembly 102, and FIG. 15b shows a left side perspective view of curving assembly 102. As shown in FIGS. 15c and 16, the curving assembly 102 includes multiple rollers 170, 172, 174, 176, 178, 180, and 182 (e.g., multiple “first” rollers using “first” as a label for convenience) supported by the frame 114. Those of skill in the art will appreciate that many variations of hardware and support members may be used to support the multiple rollers 170, 172, 174, 176, 178, 180, and 182, and any suitable combination of support members, shafts, bearings, etc., may be used. The multiple rollers include outer rollers 176, 178, 180, and 182 that contact an outer side the building panel 40, and inner rollers 170, 172, and 174 that contact an inner side of the building panel 40.

FIG. 15c also illustrates an example where rollers 170, 172, and 174 are supported by a support member 190 in the form of a D-ring, which may be made, for example, from 0.75 inch thick steel or other strong material. The multiple rollers 170, 172, 174, 176, 178, 180, and 182 are arranged at predetermined locations (e.g., “first” predetermined locations, using “first” as a convenient label) to contact the building panel as the building panel passes along the multiple rollers 170, 172, 174, 176, 178, 180, and 182 in the longitudinal direction. The other curving assemblies 104, 106, 108, and 110 similarly include frames 114 and multiple rollers supported by the frames, wherein the multiple rollers of these curving assemblies are arranged at predetermined locations to contact the building panel as the building panel passes along the multiple second rollers in the longitudinal direction. Exemplary relative positions of the multiple rollers 170, 172, 174, 176, 178, 180, and 182 are shown in more detail in FIG. 16, which will be described in greater detail below.

The panel curving apparatus 100 also includes a positioning mechanism that permits changing a relative rotational orientation between the curving assemblies 102, 104, 106, 108, and 110. For example, the positioning mechanism can include a rotatable connection between adjacent curving assemblies, such as male and female pivot blocks 150 and 154 illustrated in FIGS. 15a and 15b. A pivot pin (not shown) connects the male and female pivot blocks 150 and 154 and permits the relative rotational orientation of adjacent curving assemblies to be changed and controlled. The positioning mechanism may also include a mechanical actuator 132 to cause one curving assembly, e.g., 102 to rotate relative to an adjacent curving assembly, e.g., 104. The exemplary positioning mechanism shown in FIG. 14b also includes servo motors 136 connected through a belt drive transmission 134 to drive the mechanical actuator 132. While a mechanical actuator is shown for exemplary purposes, any suitable actuator could be used such as, for example, a hydraulic actuator, rotary actuator or other actuating mechanism. The positioning mechanism may also include ball transfer mechanisms 120 that provide nearly frictionless movement to facilitate the positioning of the curving assemblies 102, 104, 106, and 108. In the exemplary curving assembly 110, fixed supports 122 such as brackets are secured to the frame to provide a fixed inlet orientation relative to the panel forming apparatus 80.

It will be appreciated that the positioning mechanism is not limited to the example described above, which utilizes male and female pivot blocks and actuators connecting adjacent curving assemblies to provide the ability to change and control relative rotational orientation between adjacent curving assemblies. Any other suitable type of precise positioning mechanism could be used to change and control the relative rotation orientation between adjacent curving assemblies. For example, each curving assembly could be mounted on its own computer controlled, translation/rotation platforms with suitable sensors to continually monitor the positions and orientations of the curving assemblies 102, 104, 106, 108, and 110 to provide control thereof. Any suitable feedback control system using the sensed positions and orientations as feedback could be used to control the movement of the curving assemblies 102, 104, 106, 108, and 110, including suitable servomechanisms, to achieve the desired relative rotational orientations at the desired times.

The panel curving apparatus 100 also includes a drive system for moving the building panel longitudinally along the multiple rollers of the curving assemblies 102, 104, 106, 108, and 110. For example, the drive system may include hydraulic motors 124 located at each curving assembly to drive a gear train that causes rollers to turn. A gear on the shaft of hydraulic motor 124 will mesh with gear train 126 and thereby provide the rotary motion for rollers of the curving machine. Side plates 116 are used to mount all the drive and mechanical components. To obtain sufficient traction to translate the building panel 40 longitudinally, a urethane coating can be provided on rollers 172 and/or 182. This will provide enough force to drive the building panel through the panel curving apparatus 100. It will be appreciated that approaches other than urethane coatings can be used to enhance friction on these rollers, such as, for example other coatings, metal treatments, machined surfaces, etc. can be utilized to provide added friction.

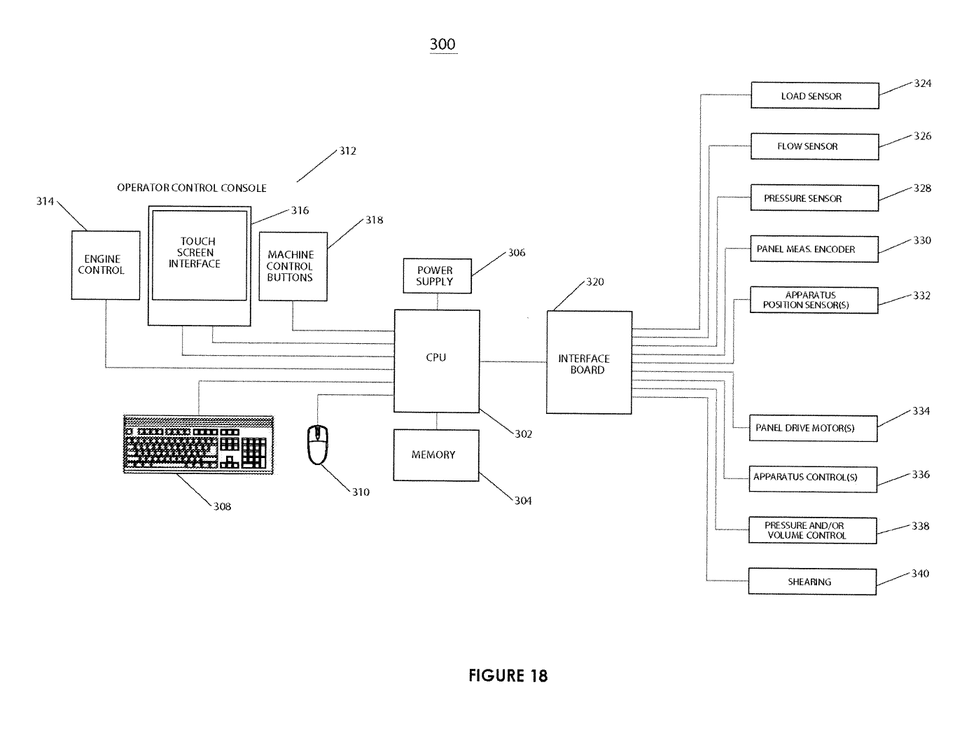

The panel curving apparatus 100 is controlled by a control system 300 (see FIG. 18), which may include a microprocessor based controller 302 (e.g., computer such as a personal computer) and a man-machine interface, such as a touch-sensitive display screen 316, for controlling actuators 132 (or more generally, for controlling a positioning mechanism) so as to control the relative rotational orientation between the curving assemblies 102, 104, 106, 108, and 110, as the building panel moves longitudinally along the multiple rollers 170, 172, 174, 176, 178, 180, and 182 to form a longitudinal curve in the building panel. A less sophisticated control system, such as user-manipulated manual controls could be used, but a microprocessor-based controller that receives sensor feedback is believed to be advantageous. In this regard, suitable sensors, such as linear and/or rotary encoders may be suitably positioned at one or more of the assemblies 102, 104, 106, 108, and 110 to monitor the length of building panel 40 processed. Rotation sensors may be suitably placed (e.g., at male and female pivot blocks 152 and 154) to monitor the relative rotational orientation between adjacent curving assemblies. Alternatively, linear sensors, e.g., placed at or near actuators 132, may be used to monitor linear changes in distance between specified points between adjacent curving assemblies wherein the change in linear displacement can be correlated to an amount of rotation between adjacent curving assemblies. Information from these various sensors can be fed back into the control system 300 to continually monitor and adjust the functioning of the panel curving apparatus 100 and the overall system 70. Additional details regarding the control system will be described elsewhere herein.

The panel curving apparatus 100 is configured to form the longitudinal curve in the building panel 40 without imparting transverse corrugations into the building panel. The multiple rollers 170, 172, 174, 176, 178, 180, and 182 of the first and second curving assemblies 110 and 108 are arranged so as to allow an increase in a depth of a particular segment of the plurality of segments of the building panel 40 to accommodate the formation of the longitudinal curve in the building panel 40a as a torque is applied to the building panel by adjacent curving assemblies.

The curved building panels and panel curving assemblies may have any dimensions suitable for a desired application, and such parameter will depend upon the particular size and shape of the longitudinally curved building panel that is desired. In exemplary embodiments, the panels may be, for example 24″ wide and 10½″ deep. Exemplary panel curving assemblies for longitudinally curving panels having these dimensions may be approximately 60″ in height, 30″ in depth, and 16″ in length. The distance between pivot assemblies of these exemplary panel curving assemblies may be approximately 24″. The approximate weight of such panel curving assemblies would be approximately 2000 lbs. each.

In the passive deformation approach, the panel curving apparatus 100 does not utilize a roller that itself forces an additional deformation into an existing segment of the building panel 40. Instead, the multiple rollers 170, 172, 174, 176, 178, 180, and 182 are configured so as to include various gaps at positions that align with existing segments of the building panel. Torque is applied to the building panel 40 via the multiple rollers as a relative rotational orientation is imposed between adjacent curving assemblies 102, 104, 106, 108, and 110 as the building panel moves longitudinally. This torque and relative rotation between curving assemblies combined with the guiding action of the multiple rollers 170, 172, 174, 176, 178, 180, and 182 causes displacement of the sheet material as the building panel 40 curves (and linearly contracts in regions of greater longitudinal curvature, as discussed previously). This displaced sheet material tends to move into the gaps designed between various ones of the multiple rollers 170, 172, 174, 176, 178, 180, and 182. This will now be described in greater detail with reference to FIGS. 15c and 16.

FIG. 16 shows a cross sectional view of an exemplary configuration of multiple rollers 170, 172, 174, 176, 178, 180, and 182 present in curving assemblies 102, 104, 106, 108, and 110. According to one exemplary aspect, a particular roller 176 is positioned adjacent to upper opposing roller 170 and lower opposing roller 170. Roller 176 is configured so as to impact the sides of segment 52 so as to permit the central portion of segment 16 to deform toward the opposing rollers 170, thereby increasing its depth. Also, the particular roller 176 is positioned adjacent to opposing rollers 170 such that a contacting surface portion of the particular roller 176 and a contacting surface portion of the opposing roller 170 contact opposing sides of the building panel 40 at a contact region, wherein a gap exists between opposing surfaces of the particular roller 176 and the opposing roller 170 adjacent to the contact region.

Also shown in cross section in FIG. 15c is a straight building panel 40 prior to imparting a longitudinal curve thereto. Building panel 40 is intended to be transformed into a longitudinally curved building panel 40a such as illustrated in FIGS. 15 and 16 by the panel curving machine 100. Consider, for example, that curving assembly 108 is rotated relative to curving assembly 110, which is stationary, as building panel moves longitudinally along the multiple rollers 170, 172, 174, 176, 178, 180, and 182 of curving assemblies 110 and 108. As the building panel 40 starts to curve longitudinally, the gap 184 between roller 176 and rollers 170 will be the area where segment 52 (FIG. 3) will be further deformed by absorbing displaced sheet material so as to form segment 52a. Roller 176 has a slight convex shape which helps direct the segment 52 into gap 184. Rollers 170 which are mounted to support member 190 (e.g., D-ring) will help support and provide the final shape of segment 52a. After segment 52 is further deformed to absorb displaced sheet material, it will resemble the segment 52a shown in FIG. 6. Adjacent segments 50 and 54 are similarly further deformed in connection with the longitudinal curving by absorbing displaced sheet material so as to form segments 50a and 54a in building panel 40a.

As noted previously, the change depth Δd1 of middle segment 52a is greater than the change in depth Δd3 of adjacent segments 44a and 46a of longitudinally curved building panel 40a. This is because the building panel 40a is being longitudinally curved to a greater extent at the middle portion of the building panel 40a near deformation 52a and is effectively having its linear length shortened to a greater extent in regions where the building panel 40a has greater longitudinal curvature, the greatest amount of longitudinal curvature occurring at the middle of the building panel 40a near segment 52a. As the building panel 40a is curved, the “excess” sheet material that is being displaced due to the longitudinal linear contraction must be absorbed someplace, and the displaced sheet material accumulates and is absorbed in the segments. Because segments 44a and 46a are located at points of lesser linear contraction of the building panel 40a compared to segment 52a, segments 44a and 46a are less deformed and less deep than segment 52a as a result of the curving process.

As shown in FIG. 16, the multiple rollers are configured to have gaps between various rollers that have sizes and shapes consistent with the expected amounts of panel deformation at different locations described above. In particular, segment 52 is permitted to deform into gap 184 between rollers 176 and 170 to ultimately form segment 52a. The shape of the segment accommodated by gap 184 is governed by the shapes of rollers 170. As noted above, roller 176 has a slight convex shape which helps direct displaced sheet material into gap 184. Gap 184 is the largest gap shown in FIG. 16. Upper and lower gaps 186 are somewhat smaller than gap 184 since less displacement of sheet material is expected there for reasons discussed above. Segments 44 and 46 shown in FIG. 3 are permitted to deform into gaps 186 to ultimately form segments 44a and 46a of FIG. 6. Rollers 170 have small convex portions which help direct displaced sheet material into gaps 186. The shape of the segment accommodated by gaps 186 is governed by the shapes of rollers 176 and 178.

Upper and lower gaps 188 are somewhat smaller than gaps 186 since less displacement of sheet material is expected there. Segments 50 and 54 are permitted to deform into gaps 188 to ultimately form segments 50a and 54a. Rollers 170 have a small convex portion which helps direct displaced sheet material into gaps 188. The shape of the segments accommodated by gap 188 is governed by the shapes of rollers 170 and 178.

In addition to the multiple rollers 170, 172, 174, 176, 178, 180, and 182 described above, supplemental rollers (not shown) may be positioned between adjacent curving assemblies 102, 104, 106, 108, and 110. The supplemental rollers can be located between curving assemblies 102, 104, 106, 108, and 110, and can be supported by a support member 190, e.g., D-ring, which is supported by the frame 116, as shown in FIG. 15c. The supplemental rollers may function to support the building panel 40a and to maintain the final form of segments 42a, 44a, 46a, 48a, 50a, 52a, and 54a. Without these supplemental rollers, the building panel 40a may tend to buckle or excessively form in the unsupported areas between the main rollers 170, 176, and 178. Such buckling is aesthetically and structurally undesirable.

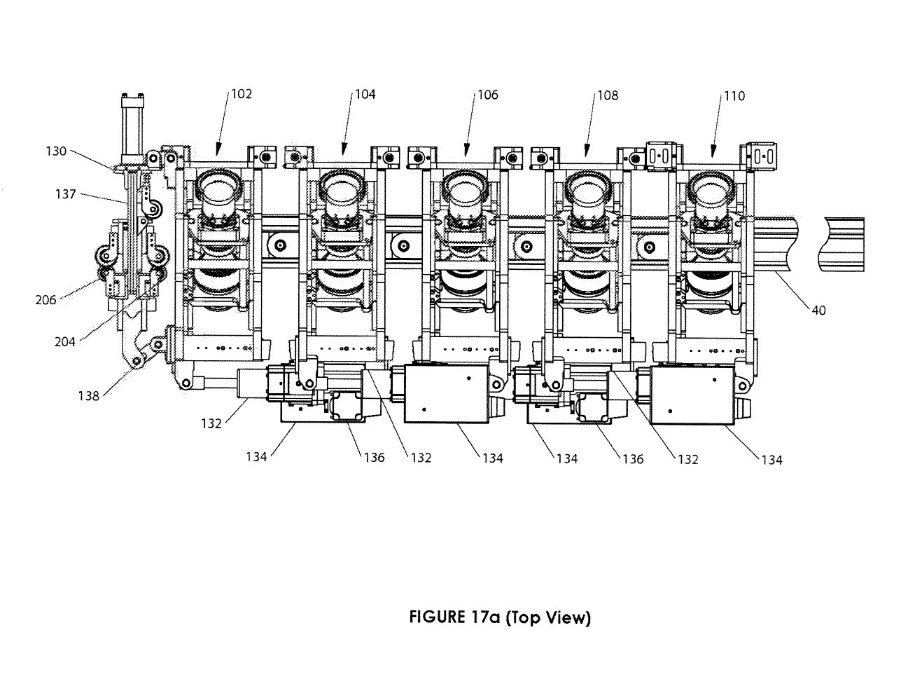

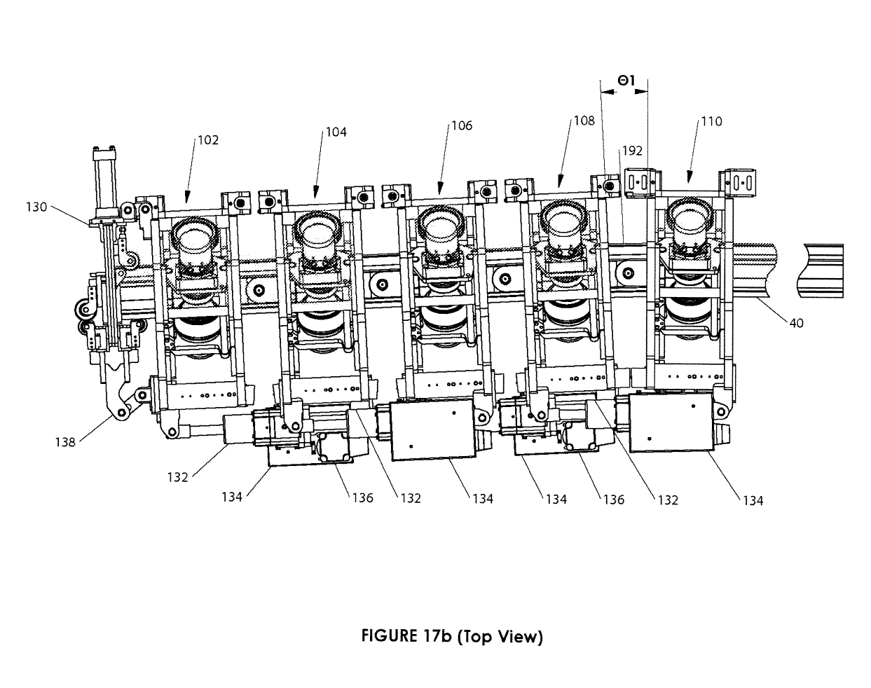

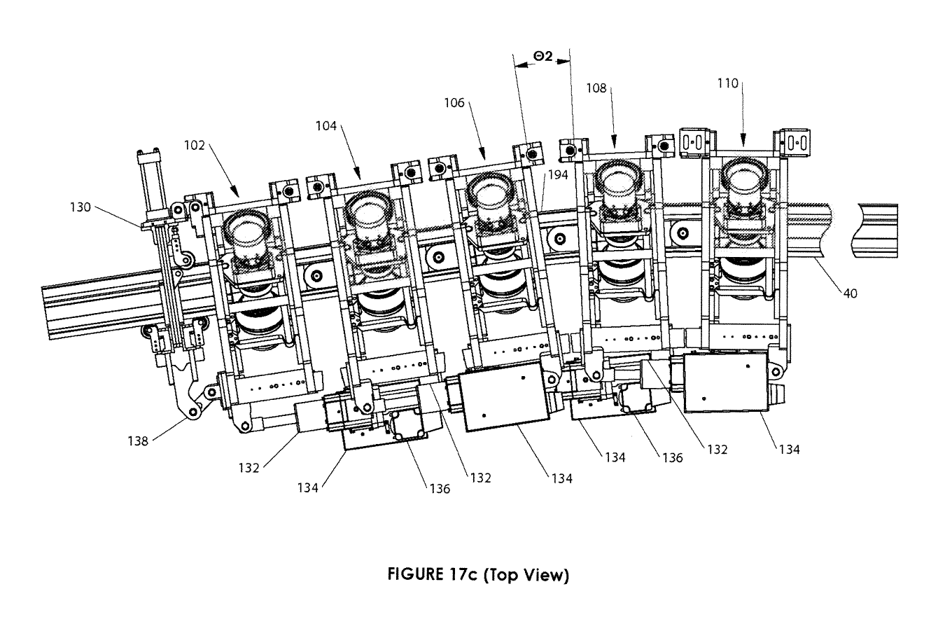

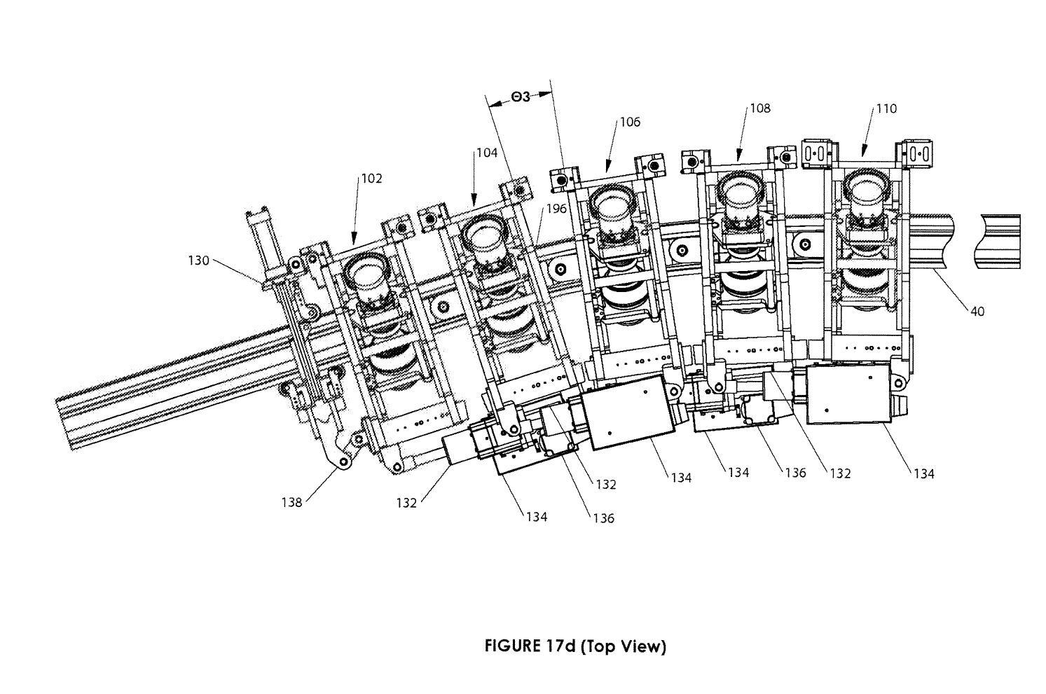

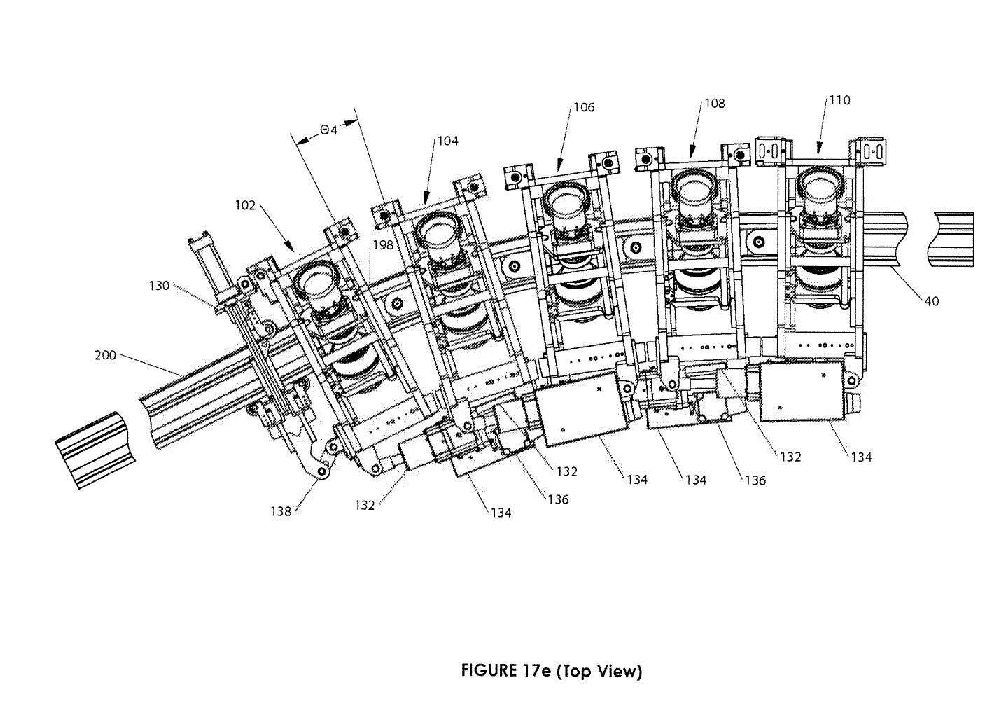

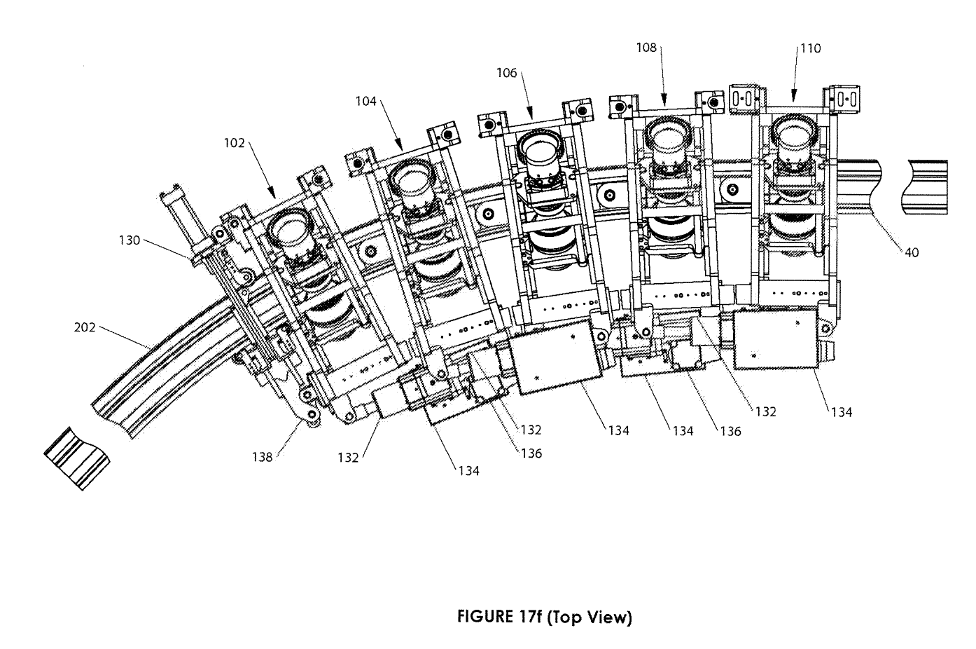

An overall operation of the panel curving machine 100 comprising multiple curving assemblies 102, 104, 106, 108, and 110 to longitudinally curve a building panel will now be described with reference to FIGS. 17a-17f. FIGS. 17a-17f show a top view of an exemplary sequence for imparting a longitudinal curve to a building panel 40. FIG. 17a shows the panel curving machine 100 before any curving of the building panel occurs. A straight building panel 40 is inserted into the first curving assembly 110 of the panel curving machine 100. Motors 124 and associated drive mechanisms, and drive rollers 170, 172, 174, 176, 178, 180, and 182 move the building panel 40 into place through all five curving assemblies 102, 104, 106, 108, and 110 without initially imparting any longitudinal curve to the building panel 40. Once the building panel 40 is inserted into curving assemblies 102, 104, 106, 108, and 110, the control system 300 can automatically begin translating the building panel 40 longitudinally and begin the curving process.

As shown in FIG. 17b, while the building panel 40 is translating longitudinally, the control system 300 causes actuator 132 to rotate curving assembly 110 relative to curving assembly 108 by an angle θ1. Curving assembly 110 is fixed in place and curving assembly 108 rotates. A sensor, e.g., any suitable optical or electronic position transducer for measuring rotation and/or translation, such as described previously herein, may be used to precisely measure the position of each curving assembly 102, 104, 106, 108, and 110. As shown in FIG. 17b a portion 192 of the building panel 40 between curving assemblies 110 and 108 is beginning to curve under the influence of the torque applied to the building panel 40 by the multiple rollers 170, 172, 174, 176, 178, 180, and 182 of curving assemblies 108 and 110. The longitudinal curve is imparted as the building panel 40 moves through the panel curving machine 100 without the need for transverse corrugations and without causing buckling. As the curving takes place, segments and segments of the building panel 40 will further deform as displaced sheet material tends to move into gaps 184, 186, and 188, as discussed previously.

Next, as shown in FIG. 17c, while the building panel 40 is translating longitudinally and when the initially curved portion 192 arrives at curving assembly 106, the control system 300 causes another actuator 132 to rotate curving assembly 106 relative to curving assembly 108 by an angle θ2 that is greater than θ1. Region 194 of the building panel is curved by an additional amount under the influence of the torque applied to the building panel by the multiple rollers 170, 172, 174, 176, 178, 180, and 182 of curving assemblies 106 and 108. The approximate angular ranges for θ1 and θ2 may be from 0° to 15°, for example. According to a non-limiting example, for a 24-inch wide panel made from 0.060 thick steel sheet metal, θ1 may range between 0° and 10°, and θ2 may range between 0° and 15°.

The longitudinal curving process as described above will continue in this manner to produce curved building panels 40 as long as desired. FIG. 17d illustrates a relative rotation of θ3 between curving assemblies 104 and 106 driven by another actuator 132 with additionally curved portion 196. And FIG. 17e illustrates a relative rotation of θ4 between curving assemblies 102 and 104 driven by another actuator 132 with additionally curved portion 198. The angle θ3 may range between about 0° and 20°, and θ4 may range between about 0° and 25°. As can be seen, the building panel 40 becomes progressively more curved in the longitudinal direction as it traverses the curving assemblies 102, 104, 106, 108, and 110.

As shown in FIG. 17e, a portion 200 of the building panel emanating from curving assembly 102 is straight because there is a minimal length of the building panel 40 that must be initially inserted into the panel curving apparatus 100 to initiate the curving process as shown in FIG. 17a. Such straight portions, which continuously connect with curved portions, are sometimes desirable to provide a straight wall section for a gable style building or a double-radius (two-radius) style building, such as shown in FIGS. 7 and 9. Straight sections 200 can be discarded or utilized in the building project as may be desired. FIG. 17f illustrates a fully curved portion 202 of the panel 40a emerging from the fifth curving assembly 102. Entirely curved building panels can be used to fabricate the curved portions of arch style buildings such as shown in FIG. 8.

A suitable shearing device 130 (e.g., a guillotine) can be positioned near the curving assembly 102 to shear the building panel 40 at desired lengths for a given building project, and the shearing device can be controlled by the control system 300 as well. The shearing device 130 may be driven by hydraulic cylinders 140 or any other suitable power source (e.g., pneumatic or mechanical actuators).

As illustrated in FIGS. 14b and 17a, an exemplary shearing device 130 may be mounted in a frame 137 attached to a floating linkage 138 that tracks the panel emerging from the fifth curving assembly 102 so as to maintain the shearing device in a perpendicular orientation to the longitudinal direction of the building panel emerging from the fifth curving assembly 102. In the “passive” deformation approach, inside following rollers 204 and outside following rollers 206 mounted on the frame 137 ride along the portion of the panel passing through the shearing device 130 as the panel is curved, thereby forcing the frame 137 to cause the floating linkage 138 to follow the current end of the building panel. Alternatively, in an “active” deformation approach as described below, a controller (e.g., control system 300 of FIG. 18) could drive an actuator to maintain the shearing device perpendicular to the longitudinal direction of the building panel emerging from the fifth curving assembly 102. This actuator could be, for example, servomechanical, hydraulic, rotary, or any other suitable actuator. The controller 300 may track the relative orientation of the building panel to the shearing device by way of any suitable sensors. For example, suitable analog position transducers or digital optical encoders could be mounted on a pivot on top of the frame 137 to measure relative orientation between the building panel emerging from the fifth curving assembly 102 and the frame 137.

A sensor such as previously described can be used at one or more locations to make length measurements on the building panels 40a being formed, and these measurements can be fed to the control system 300 so that the control system 300 can control the shearing process to achieve building panels 40a of desired length and to achieve building panels having multiple radii, should that be desired.

In addition to the “passive” deformation approach described above, exemplary embodiments may also use an “active” deformation approach as described in U.S. Patent Application Publication No. 2010-0146789, which is incorporated herein by reference in its entirety. Whereas the exemplary panel curving apparatus 100 described above can be viewed as relating to a “passive” deformation approach insofar as certain rollers are positioned with gaps therebetween to accommodate the accumulation of sheet material of the building panel as the longitudinal curve is formed in the building panel, the “active” deformation approach forcibly deforms various segments of the building panel.

FIG. 18 illustrates an exemplary control system 300 that can be used relative to other aspects of a panel curving system according to an exemplary aspect. In exemplary embodiments, the control system is a closed-loop feedback system configured to continually monitor and adjust the relative rotational orientation between the curving assemblies as the building panel moves longitudinally along the multiple rollers of the curving assemblies such that a longitudinal curve is formed in the building panel as described above. The control system is typically managed by a microprocessor-based central processing unit (CPU) 302, for example a Windows OS computer, having interfaces to various components. A less sophisticated control system, such as user-manipulated manual controls could be used, but a microprocessor-based controller capable of receiving sensor feedback is believed to be preferable. The CPU executes program instructions stored in a memory 304, which may include a computer-readable medium, such as a magnetic disk or other magnetic memory, an optical disk (e.g., DVD) or other optical memory, RAM, ROM, or any other suitable memory such as Flash memory, memory cards, etc.

A user interacts with the CPU via input/output (I/O) devices that may be collectively referred to herein as a man-machine interface. These I/O devices can include, for example, a touch screen display interface 316, a keyboard 308, and a mouse 310. The CPU 302 is also connected to a CPU power supply 306.

The CPU 302 is attached via a bus, for example a Serial Peripheral Interface (SPI) bus, to an interface board 320. The interface board 320 includes peripheral interface components such as analog-to-digital and digital-to-analog converters for sending outputs to and receiving inputs from various other aspects of a panel curving system. The interface board 320 may be, for example, a simple I/O controller driven by the CPU 302 or a stand-alone microcontroller in communication with the CPU 302 that includes its own onboard CPU and memory. The interface board 320 communicates with a set of machine control buttons 318 to receive various inputs. In addition, the interface board 320 communicates with the engine control interface 314 that controls the power supply 76, e.g., a diesel engine of FIG. 10a.

The interface board 320 has a number of interfaces for controlling components of the system 70. For example, the interface board 320 includes panel drive motor controls 334 for moving the building panel longitudinally along the multiple rollers of the curving assemblies. It also includes apparatus controls 336 for controlling the actuators 132 of FIG. 14b (e.g., servomechanical actuators, hydraulic actuators, rotary actuators or other actuating mechanisms). As previously discussed, the actuators 132 control the relative angles of the panel curving assemblies. Pressure and/or volume controls 338 for the hydraulic power source may also be included. Finally, a shearing control 340 for operating the shear 130 of FIG. 14a can be provided.

The interface board also receives system parameters from components of the system 70. The relative angle between the panel curving assemblies is monitored by position sensors 332, for example by measuring the position of each of the actuators. The position sensors may be any suitable component capable of providing an electrical signal to the interface board that indicates the position of the actuator, such as, for example, any suitable analog position transducer or digital optical encoder. The output of the position sensors 332 is fed back to the interface board 320. The panel drive motor 334 provides torque to translate the building panel through the curving assemblies while panel measurement encoder 330 sends a signal to the interface board 320 indicating the length of the panel processed. Load sensors 324, flow sensors 326, and pressure sensors 328 can also provide indicators of the status of the power supply 76 and/or the hydraulic plant.

In light of the above descriptions, according to an exemplary aspect, a method of forming a flat sheet of material into a building panel may comprise various steps, including receiving a flat sheet of material from a coil, driving the sheet longitudinally along multiple first rollers and multiple second rollers, impacting the sheet as the sheet passes along the multiple first rollers in the longitudinal direction such that the sheet is formed into a first shape in cross section, and then impacting the sheet having the first shape as the sheet passes along the multiple second rollers in the longitudinal direction such that the sheet is formed into a second shape in cross section, the second shape having a first face and an opposite second face, and a pair of edges at the outermost ends of the second shape. Furthermore, a subset of the multiple second rollers can be arranged to bend one edge portion of the sheet in a curved manner in cross section so that the edge portion of the sheet comprises a loop. As described elsewhere herein, the second shape comprises a building panel having a first side portion and a second side portion extending from respective ends of a center portion in cross section, a first connecting portion extending from the first side portion, the first connecting portion comprising a loop in cross section, and a second connecting portion extending from the second side portion, the second connecting portion comprising a hook in cross section. In certain aspects, the first shape and the second shape are arcuate, and the second shape has a greater radius of curvature than the first shape.

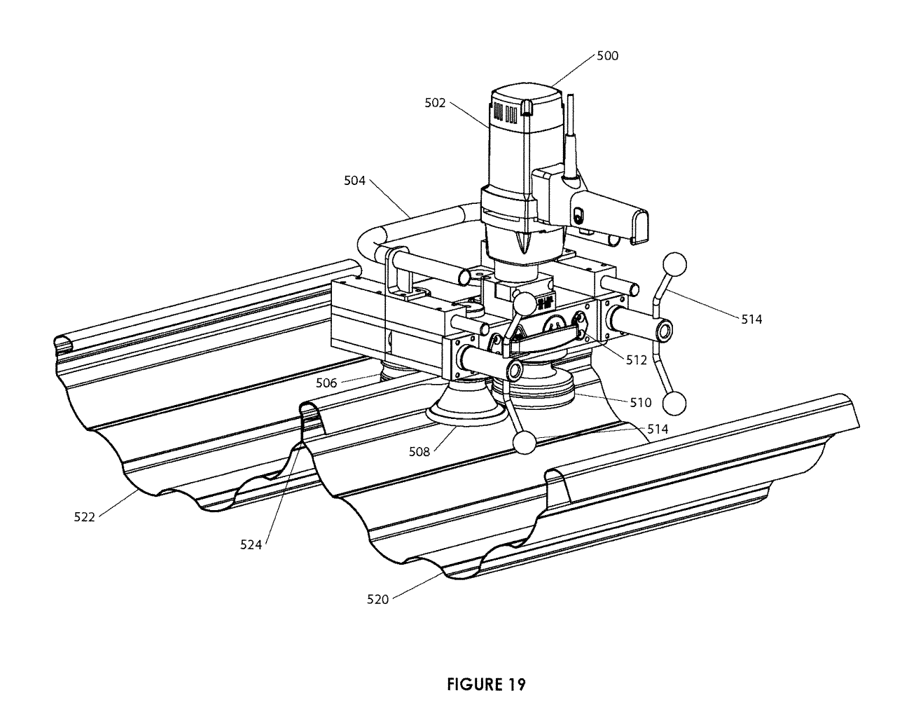

An exemplary seaming apparatus for joining panels having hook and loop connecting portions will now be described. FIG. 19 shows a side elevation view of a seaming apparatus 500 comprising a main support frame 504, a power source in the form of an electric gear motor 502 mounted on the support frame 504 and a panel-engaging assembly generally in the form of two sets of rollers.

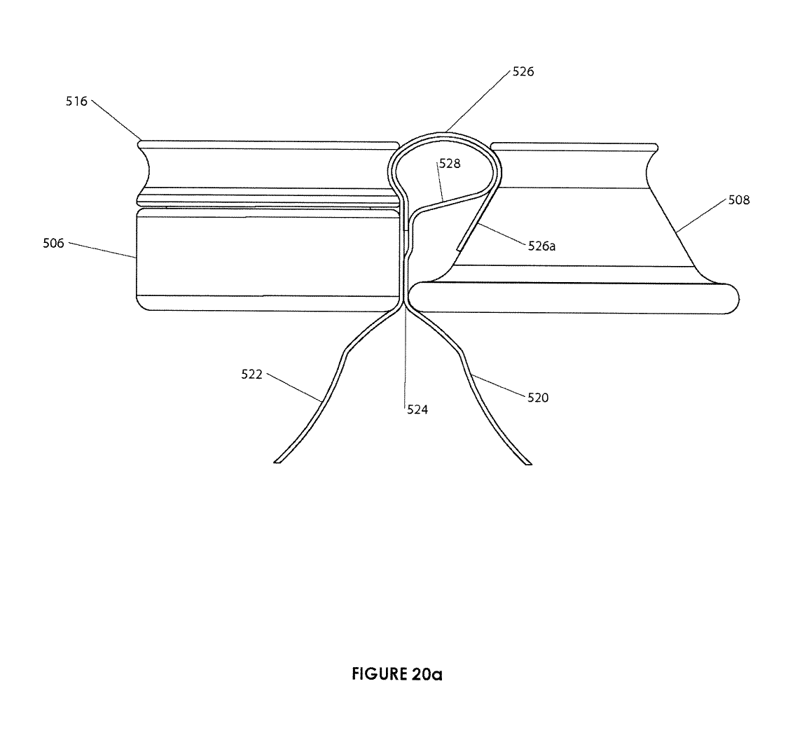

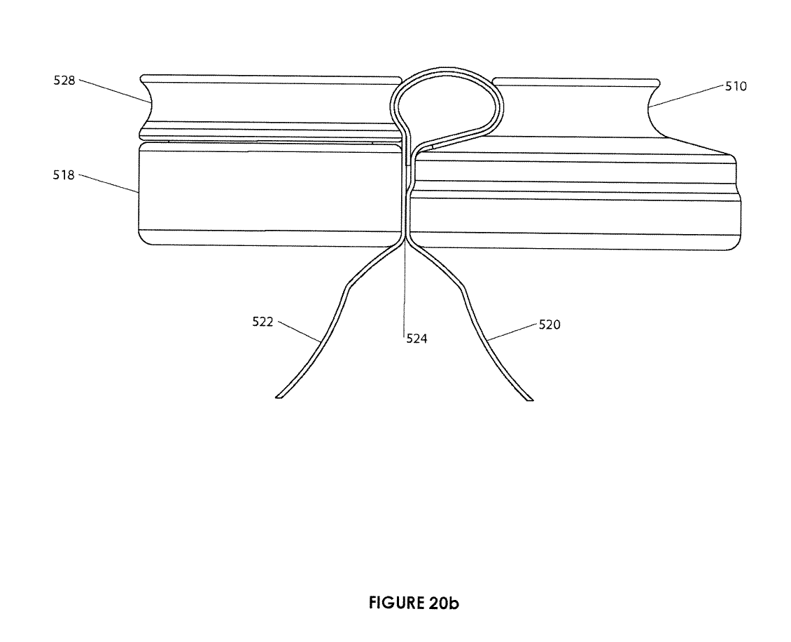

As illustrated in FIGS. 20a and 20b, the first set of rollers include lower power driven roller 506 and upper power driven roller 516. The lower power driven roller 506 may include a urethane contacting surface to enhance traction against building panels, while the upper power driven roller 516 may be uncoated steel. Horizontally opposing the rollers 506, 516 is a first forming roller 508. The second set of rollers include lower power driven roller 518 and upper power driven roller 528. The lower power driven roller 518 may also include a urethane similar to roller 506. Horizontally opposing the rollers 518, 528 is a second forming roller 510. The electric motor 502 is coupled to the two sets of power driven upper and lower rollers via any suitable mechanism such as a gear and chain drive train, which is generally enclosed within housing 512.

The upper power driven rollers 516, 528 guide the seaming apparatus as it moves forward along the seam. The two bottom power driven rollers (also referred to as bottom drive rollers) 506, 518 grip the panel in combination with the forming rollers 508, 510 and drive the seaming apparatus. Several rollers are typically adjustably mounted so that they are capable of moving vertically along their axles independent of the other rollers. In particular, certain rollers may be coupled to handles 514 via threaded adjustment bolts and gears so that the rollers can be moved to accommodate mounting the seaming apparatus on various building panels.

In FIG. 20a, the complementary connecting portions of two building panels 520, 522 are shown joined together to form a junction 524. Building panel 522 includes a hook connecting portion 526 that has a vertical edge 526a, and building panel 520 includes a loop connecting portion 528. The seaming process involves bending vertical edge 526a under the bottom portion of the loop 528 to form a tight seam.

To begin the seaming process, the seaming apparatus 500 is mounted on the panels to be seamed. After mounting, the bottom drive roller 506 is in firm frictional contact with the edge of building panel 522 and forming roller 508 is firmly engaged with vertical portion 526a of the other building panel 520. When the motor 502 is engaged, drive rollers 506, 516 drive the seaming apparatus 502 forward. The opposing forming rollers 508, 510 then force the vertical edge 526a inwards to seal around the loop 528 thereby forming a tight seam, with forming roller 510 causing most of the bending action.

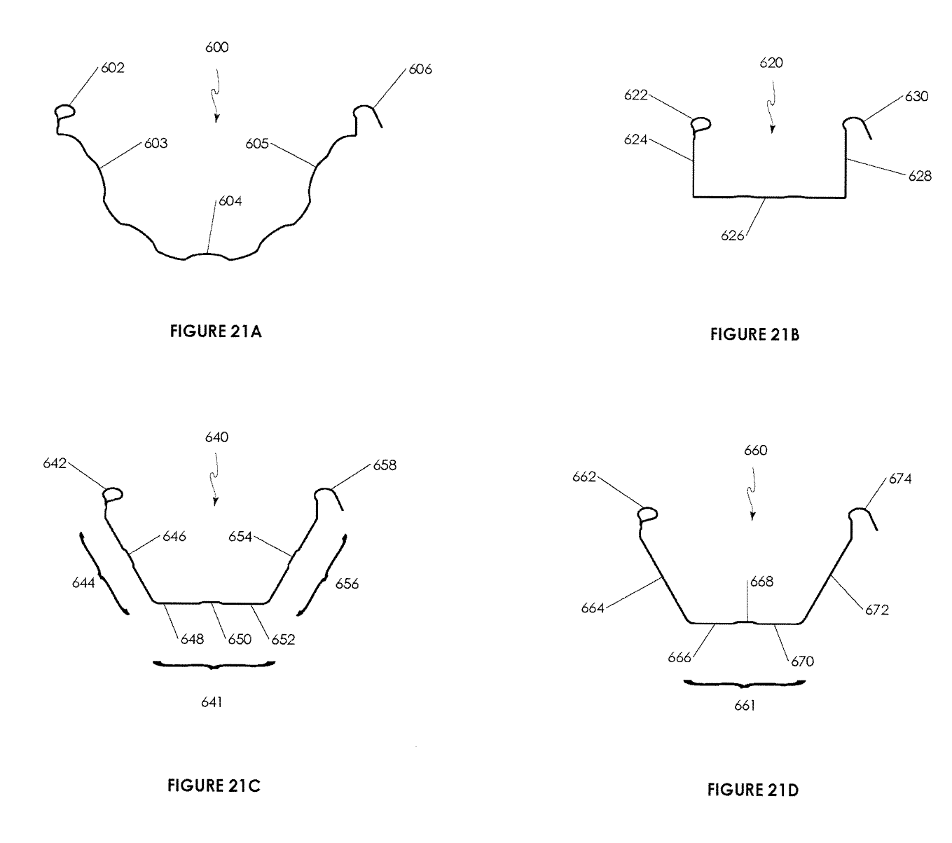

Advantageously, hook and loop connecting portions described herein can be used with a variety of building panels and are not limited to building panels with cross sections such as shown in FIG. 3-6. FIGS. 21a-21d illustrate cross sectional shapes of several other exemplary building panels that may use hook and loop connecting portions. FIG. 21a illustrates an exemplary building panel 600. The panel 600 comprises a central portion 604, from the ends of which extend a pair of outwardly diverging inclined side wall portions 603, 605. Extending from one inclined side wall portion 603 is a connecting portion 602 configured as a loop, and extending from the other inclined side wall portion 605 is a connecting portion 606 configured as a hook that is complementary to the loop.

FIG. 21b shows an exemplary building panel 620 having a flat central portion 626 in cross section. Extending perpendicularly from both edges of the flat central portion 626 are side wall portions 624, 628. Extending from the end of side wall portion 624 is a connecting portion 622 comprising a loop, and extending from the end of side wall portion 628 is a connecting portion 630 comprising a hook.

FIG. 21c illustrates an exemplary building panel 640 that comprises a central portion 641 from the ends of which extend, preferably at a 45° angle, a pair of inclined side wall portions 644, 656. At the end of one side wall portion 644 is a loop portion 642. Located at the end of the other side wall portion 656 is a complementary hook portion 658 capable of receiving the loop portion 642. Notched portions 646, 654 are included within the inclined side wall portions 644, 656, respectively, at a location preferably between the neutral axis and the central portion (i.e., below the neutral axis). It is even more preferable that the notched portions 646, 654 be included within the inclined side wall portions 644, 656 at approximately halfway between the neutral axis and the central portion 641. The building panel 640 also includes a notched central portion 650 within the central portion 641, thereby creating two sub-central portions 648, 652.

FIG. 21d illustrates an exemplary building panel 660 that includes a central portion 661 and two inclined side wall portions 664, 672 extending from opposite ends of the central portion 661. The central portion 661 includes a notched portion 668, thereby separating the central portion 661 into two sub-central portions 666, 670. A loop portion 662 extends from one side wall portion 664, and a complementary hook portion 674 extends from the other side wall portion 672.

In certain embodiments, the control system 300 of FIG. 18 may implement adaptive control of the drive system such as described in U.S. patent application Ser. No. 13/159,752 entitled Systems and Methods For Making Panels From Sheet Material Using Adaptive Control, filed Jun. 14, 2011, the entire contents of which are incorporated herein by reference. In an adaptive control system, the drive system can be controlled in response to a signal from a load sensor and an optional speed sensor so as to control the load on the power supply (e.g., a diesel engine) as the building panel moves along the panel forming apparatus 80 and/or panel curving apparatus 100 of FIG. 10a. The purpose of the load sensor and optional speed sensor is to provide a signal to aid in determining whether the power supply is being put under too great a load during an operation of forming and curving the building panel. If the power supply is placed under too great a load, it may stall or malfunction.

To implement adaptive control, the system 70 of FIG. 10a can include a load sensor for generating a signal indicative of the load placed on the power supply 76 during operation of the system 70. Where the power source is or includes a motor, such as a diesel engine or an electric motor, the load sensor can be any suitable tachometer or other device (e.g., alternator with suitable electronic decoder such as a frequency-to-voltage signal conditioner) for generating a signal indicative of (e.g., proportional to or correlated to) the rotational speed of a motor shaft. In some instances, e.g., where hydraulics are used for the drive system and where the hydraulic system utilizes fixed displacement hydraulic pumps, a flow meter that monitors the flow rate of hydraulic fluid could be used as a load sensor (instead of or in addition to a tachometer), since in such instances, the flow rate of hydraulic fluid is expected to decrease if excessive loads are placed on the power source. Alternatively, where an electronically controlled engine is used, the load signal (e.g., an electronic signal indicative of the rotational speed of the engine or indicative of power output of the engine) may be obtained directly from the engine control unit (ECU) of the engine which generates such a signal. When the power source is an electric motor the load sensor could alternatively be an ammeter that measures input current to the motor, and the load on the motor can be monitored by measuring that input current. In any of these examples, the load sensor can be considered to measure or provide a signal indicative of a load parameter, which is a parameter indicative of the load placed on the power source. In the examples described above, the load parameter can be, for example, a signal indicative of rotational speed of a motor shaft, a signal indicative of the flow rate of hydraulic fluid, or a signal indicative of the input current to an electric motor. It should be understood that the load sensor and the load parameter are not limited to these examples.

The system 70 may also include a speed sensor for measuring the speed of the building panel as it passes through the panel forming apparatus 80 or the panel curving apparatus 100 in the example of FIG. 10a. The speed sensor can provide a signal indicative of the linear speed of the building panel so as to be able to control the linear speed at which the panel is shaped. The speed sensor can include a measuring wheel that is spring loaded so as to press against a building panel that passes by and that rotates according to the linear speed of the building panel. The speed sensor can also include an encoder that provides a signal indicative of either the linear speed of the building panel or the rotational speed of the measuring wheel, which, in any event, can be correlated to the linear speed of the building panel. The speed sensor can be attached via a mounting bracket to the frame of any suitable component, e.g., the frame of the panel forming apparatus 80 or the panel curving apparatus 100, such that the measuring wheel is positioned to contact the building panel that passes by. Of course, the speed sensor is not limited to this example, and any suitable speed sensor that provides a signal indicative of the linear speed of the building panel (e.g., including a signal that may be correlated to the linear speed of the building panel) can be used.

Referring to FIG. 18, the control system 300 can be configured to control the drive system in response to signals from the load sensor and optionally from the speed sensor so as to control a drive parameter (e.g., hydraulic fluid pressure or flow rate, which can control the speed of a hydraulic drive motor), and thereby control a speed at which the building panel moves along panel forming apparatus 80 and/or panel curving apparatus 100. This feedback may prevent the system 70 from becoming overloaded and stalling under excessive loads.

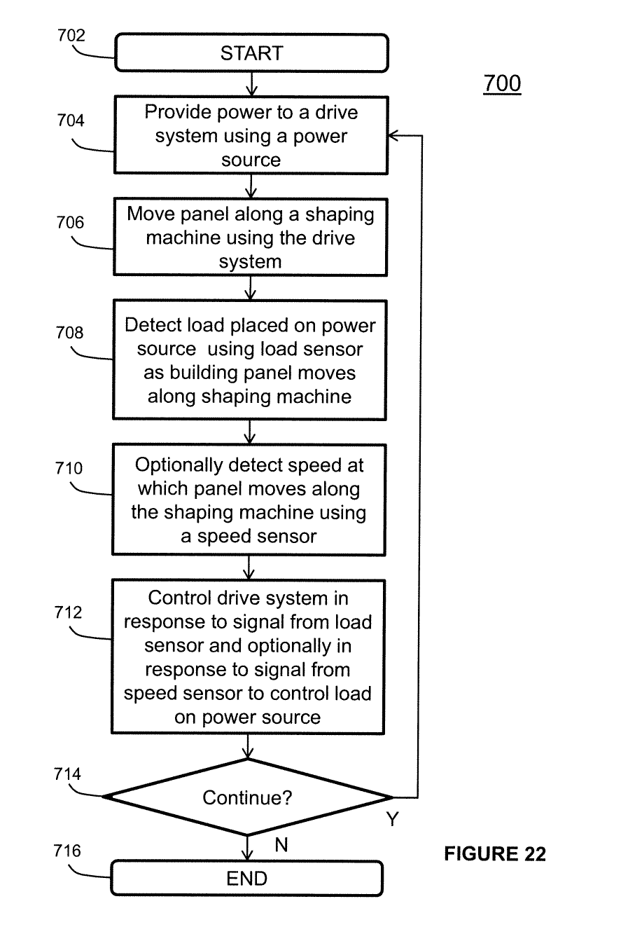

FIG. 22 illustrates a flow chart for an exemplary approach 700 for implementing adaptive control to shape a building panel. The method starts at step 702, and at step 704 power is provided to drive system (e.g., a hydraulic drive system including hydraulic pumps, hydraulic motors, etc.) by a power source, such as power supply 76 as discussed previously herein. The power supply is initially adjusted to nominally run at a desired operating speed, e.g., 2500 revolutions per minute (RPM) for instance for a diesel engine under control of a governor, such as conventionally known to those of ordinary skill in the art. At step 704 the drive system (e.g., including urethane coated drive rollers that grip the panel) is engaged to move the panel along panel forming apparatus 80 or a panel curving apparatus 100 at a given target speed.

At step 708, the load placed on the power supply 76 is detected using a load sensor as the panel traverses the panel forming apparatus 80 and/or the panel curving apparatus 100. The present inventors have found that using a tachometer or alternator with a frequency-to-voltage signal conditioner (or other rotation type sensor) as the load sensor for detecting the rotational speed of a motor shaft is advantageous.

Optionally, at step 710, a speed at which the panel moves along the shaping machine can be detected using a speed sensor. It should be understood that detecting the speed of the panel does not necessarily mean that an actual speed value must be generated in units of length per unit time. Rather, to detect panel speed, it is sufficient to generate a signal, e.g., a voltage signal, with the speed sensor that is indicative of speed, e.g., proportional to or correlated to speed via any suitable calibration or correlation.

At step 712, the drive system is controlled in response to signals from the load sensor, and optionally from the speed sensor, to control the load on the power source 76 (e.g., to reduce the load on the power source by reducing the speed of the panel) as the panel moves during processing of the panel. For example, the drive system can be controlled using a processing system such as CPU 302 previously described in connection with control system 300 illustrated in FIG. 18. The control of the drive system can be carried out in a variety of ways depending upon the system configuration at hand. In various examples, the CPU 302 can control the drive system to reduce the load on the power source 76 if the load on the power supply exceeds a target (desired) level so as to prevent the power supply 76 from becoming overloaded or stalling. In one example, the power supply 76 can be a diesel engine (or an electric motor powered by a generator), the load sensor can be a tachometer or alternator with a frequency-to-voltage signal conditioner (in which case the load parameter can be the rotational speed of a motor shaft), the drive system can include variable pressure hydraulics to drive a hydraulic motor, and the drive parameter can be hydraulic fluid pressure.

The CPU 302 can control the drive system by initially increasing the hydraulic fluid pressure to a hydraulic panel drive motor to gradually ramp up the panel speed, while monitoring the load on the power source 76 by monitoring the rotational speed of a motor shaft. The panel speed can be increased by increasing the hydraulic fluid pressure until the target panel speed is achieved or until a desired load on the power source is achieved, i.e., until the load parameter reaches a target value. For example, the hydraulic fluid pressure can be increased until the rotational speed (load parameter) of a motor shaft drops from a no-load value (e.g., 2500 RPM—determined when a panel was not being processed) by some predetermined amount (e.g., drops by 200 RPM to 2300 RPM). In this example, the target value of the load parameter would be 2500 RPM−200 RPM=2300 RPM. When the target value of the load parameter has been achieved (e.g., the rotational speed has dropped from the no-load value by a predetermined amount such as 200 RPM), the hydraulic fluid pressure is not increased further. At that point, the processing system (e.g., CPU 302) may control the system 70 so as to maintain the value of the load parameter at or slightly above its target value, e.g., 2300 RPM. If, during operation, the power supply experiences too great a load, e.g., the engine speed drops below the target value (e.g., 2300 RPM in this example), the drive parameter can be further changed by a suitable amount (e.g., according to a predetermined step size), e.g., the pressure of the hydraulic fluid can be decreased by a step amount (corresponding to a slower panel speed), until the load on the power source is reduced below the target value (e.g., the engine rotational speed returns to above 2300 RPM). For instance, the hydraulic fluid pressure can be changed by an increment (step amount) that is known from trial and error testing to increase the engine RPM under typical circumstances by 5, 10, 15, 20 or 30 RPM. In certain embodiments, the processing system (e.g., CPU 302) can be configured so as to maintain the load parameter within some target range of permissible values, e.g., within a specified range of the target value, such as ±5 RPM, ±10 RPM, +15 RPM, ±20 RPM, +25 RPM, etc., where a rotational speed of a motor shaft is used as the load parameter.

At step 714, the CPU 302 determines whether or not to continue shaping the panel. For example, if the CPU 302 detects that a stop condition has occurred, such as whether the drive system stop switch has been engaged, the shaping process ends at step 716 with the drive system being halted. Otherwise, if no stop condition has arisen, the process returns to step 704, with power continuing to be provided to the drive system, and with the remaining steps being executed as described above. The loop may be repeated at any suitable speed. For example, the present inventors have found it advantageous to repeat such loop processing every 50 milliseconds.

While the present invention has been described in terms of exemplary embodiments, it will be understood by those skilled in the art that various modifications can be made thereto without departing from the scope of the invention as set forth in the claims.

1. A building panel formed from sheet material, the building panel extending in a longitudinal direction along its length and having a shape in cross section in a plane perpendicular to the longitudinal direction, the building panel comprising:
a center portion in cross section;
a first connecting portion connected at one side of the center portion, the first connecting portion comprising a loop in cross section; and
a second connecting portion connected at an opposing side of the center portion, the second connecting portion comprising a hook in cross section;
wherein the loop and the hook are complementary in size and shape for joining the building panel to adjacent building panels.

2. The building panel of claim 1 further comprising a first side portion and a second side portion extending from respective ends of the center portion, wherein the first connecting portion extends from the first side portion and the second connecting portion extends from the second side portion.

3. The building panel of claim 2 wherein the center portion is curved in cross section.

4. The building panel of claim 3 wherein the curved center portion includes a plurality of segments comprising multiple outwardly extending segments and multiple inwardly extending segments in cross section, the plurality of segments extending in the longitudinal direction.

5. The building panel of claim 4 wherein the building panel is curved in the longitudinal direction along its length without having transverse corrugations therein, and wherein a particular segment of the plurality of segments has a depth greater than that of another segment to accommodate the longitudinal curve in the building panel.

6. The building panel of claim 1 wherein the loop and the hook can be brought into resiliently biased engagement with the adjacent building panels.

7. The building panel of claim 1 wherein the sheet material comprises sheet metal having a thickness of between about 0.035 inches and about 0.080 inches.

8. The building panel of claim 1 comprising a curved center portion having a curved shape in cross section, the curved center portion including a plurality of stiffening ribs formed in the sheet material, the stiffening ribs being oriented longitudinally along a length of the building panel and being positioned within a region of the curved shape, the stiffening ribs protruding in cross section relative to said curved shape.

9. A building structure comprising a plurality of interconnected building panels, each building panel extending in a longitudinal direction along its length and having a shape in cross section in a plane perpendicular to the longitudinal direction, each building panel comprising:
a center portion in cross section;
a first connecting portion connected at one side of the center portion, the first connecting portion comprising a loop in cross section; and
a second connecting portion connected at an opposing side of the center portion, the second connecting portion comprising a hook in cross section;
wherein the loop and the hook are complementary in shape for joining the building panel to adjacent building panels.

10. The building structure of claim 9, each building panel further comprising a first side portion and a second side portion extending from respective ends of the center portion, wherein the first connecting portion extends from the first side portion and the second connecting portion extends from the second side portion.

11. The building structure of claim 10 wherein the center portion of each building panel is curved in cross section.

12. The building structure of claim 11 wherein the curved center portion includes a plurality of segments comprising multiple outwardly extending segments and multiple inwardly extending segments in cross section, the plurality of segments extending in the longitudinal direction.

13. The building structure of claim 12 wherein each building panel is curved in the longitudinal direction along its length without having transverse corrugations therein, and wherein a particular segment of the plurality of segments has a depth greater than that of another segment to accommodate the longitudinal curve in the building panel.

14. The building structure of claim 9 wherein the loop and the hook on each building panel can be brought into resiliently biased engagement with the adjacent building panels.

15. The building structure of claim 9 wherein the sheet material comprises sheet metal having a thickness of between about 0.035 inches and about 0.080 inches.

16. The building structure of claim 9 comprising a curved center portion having a curved shape in cross section, the curved center portion including a plurality of stiffening ribs formed in the sheet material, the stiffening ribs being oriented longitudinally along a length of the building panel and being positioned within a region of the curved shape, the stiffening ribs protruding in cross section relative to said curved shape.

17. A system configured to form a flat sheet of material into a building panel extending in a longitudinal direction along its length and having a shape in cross section in a plane perpendicular to the longitudinal direction, the system including a panel forming apparatus comprising:
an entry guide adapted to receive a flat sheet of material;
a first forming assembly positioned adjacent to the entry guide, and a second forming assembly positioned adjacent to the first forming assembly,
the first forming assembly including a first frame and multiple first rollers supported by the first frame, the multiple first rollers arranged to impact a flat sheet of material as the sheet passes along the multiple first rollers in the longitudinal direction such that the sheet is formed into a first shape in cross section;
the second forming assembly including a second frame and multiple second rollers supported by the second frame, the multiple second rollers arranged to impact the sheet having the first shape as the sheet passes along the multiple second rollers in the longitudinal direction such that the sheet is formed into a second shape in cross section, the second shape having a first face and an opposite second face, and a pair of edges at the outermost ends of the second shape; and
a drive system for moving the sheet longitudinally along the multiple first rollers and the multiple second rollers;
wherein a subset of the multiple second rollers is arranged to bend one edge portion of the sheet in a curved manner in cross section so that the edge portion of the sheet comprises a loop;
such that the second shape comprises a building panel having a first side portion and a second side portion extending from respective ends of a center portion in cross section, a first connecting portion extending from the first side portion, the first connecting portion comprising a loop in cross section, and a second connecting portion extending from the second side portion, the second connecting portion comprising a hook in cross section.

18. The system of claim 17 further comprising:
a support structure;
a coil holder supported by the support structure for holding a coil of sheet material, coil holder being proximate the panel forming apparatus; and
a panel curving apparatus supported by the support structure and positioned proximate the panel forming apparatus to receive the straight building panel from the panel forming apparatus, the panel curving apparatus configured to impart a longitudinal curve to the building panel along the length of the building panel.

19. The system of claim 18 wherein the panel curving apparatus includes a shearing device mounted on a floating linkage, wherein the floating linkage is configured to track the building panel emerging from the panel curving apparatus so as to maintain the shearing device in a perpendicular orientation to the longitudinal direction of the building panel.

20. The system of claim 17 wherein the first shape and the second shape are arcuate, the second shape having a greater radius of curvature than the first shape.

21. A method of forming a flat sheet of material into a building panel extending in a longitudinal direction along its length and having a shape in cross section in a plane perpendicular to the longitudinal direction, the method comprising:
receiving a flat sheet of material from a coil;
driving the sheet longitudinally along multiple first rollers and multiple second rollers;
impacting the sheet as the sheet passes along the multiple first rollers in the longitudinal direction such that the sheet is formed into a first shape in cross section;
impacting the sheet having the first shape as the sheet passes along the multiple second rollers in the longitudinal direction such that the sheet is formed into a second shape in cross section, the second shape having a first face and an opposite second face, and a pair of edges at the outermost ends of the second shape;
wherein a subset of the multiple second rollers is arranged to bend one edge portion of the sheet in a curved manner in cross section so that the edge portion of the sheet comprises a loop;
such that the second shape comprises a building panel having a first side portion and a second side portion extending from respective ends of a center portion in cross section, a first connecting portion extending from the first side portion, the first connecting portion comprising a loop in cross section, and a second connecting portion extending from the second side portion, the second connecting portion comprising a hook in cross section.

22. The method of claim 21 wherein the first shape and the second shape are arcuate, the second shape having a greater radius of curvature than the first shape.

23. The method of claim 21 further comprising:
imparting a longitudinal curve to the building panel along the length of the building panel; and
shearing the curved building panel with a shearing device mounted on a floating linkage, wherein the floating linkage is configured to track the curved building panel so as to maintain the shearing device in a perpendicular orientation to the longitudinal direction of the curved building panel.
